(19) United States
(12) Patent Application Publication
(10) Pub. No.: US 2012/0067236 A1
(43) Pub. Date: Mar. 22, 2012

(54) RESIN COMPOSITION FOR LASER ENGRAVING, RELIEF PRINTING PLATE PRECURSOR FOR LASER ENGRAVING AND PROCESS FOR PRODUCING SAME, AND RELIEF PRINTING PLATE AND PROCESS FOR MAKING SAME

(75) Inventor: Hisao YAMAMOTO, Haibara-gun (JP)

(73) Assignee: FUJIFILM CORPORATION, Tokyo (JP)

(21) Appl. No.: 13/238,706

(22) Filed: Sep. 21, 2011

(30) Foreign Application Priority Data
Sep. 21, 2010 (JP) 2010-211381

(51) Int. Cl. B41N 1/06; C08L 39/04; C08K 3/34; C08K 3/22; B05D 3/06; C08K 3/36; C08K 3/04; C08J 7/04; B05D 3/10; C08F 230/08; C08J 3/28

(52) U.S. Cl. 101/395; 526/279; 524/530; 524/449; 524/430; 524/431; 524/432; 524/433; 522/117; 522/121; 522/172; 427/515; 427/387; 427/555; 427/510

(57) ABSTRACT

A resin composition is provided that includes (Component A) a filler having an ethylenically unsaturated group, (Component B) a polymerizable compound having an ethylenically unsaturated group, and (Component C) a polymerization initiator. There are also provided a relief printing plate precursor, a process for producing a relief printing plate precursor that includes a layer formation step of forming a relief-forming layer and a crosslinking step of thermally crosslinking the relief-forming layer, and a process for making a relief printing plate that includes an engraving step of laser-engraving the crosslinked relief-forming layer so as to form a relief layer.

### BACKGROUND OF THE INVENTION

1. Technical Field

The present invention relates to a resin composition for laser engraving, relief printing plate precursor for laser engraving and a process for producing the same, and a relief printing plate and a process for making the same.

2. Background Art

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As the relief printing plate precursor for laser engraving, those described in JP-A-2003-26950 (JP-A denotes a Japanese unexamined patent application publication) or JP-A-2008-81732 are known.

### SUMMARY OF THE INVENTION

### Problems to be Solved by the Invention

It is an object of the present invention to provide a resin composition for laser engraving that can give a relief printing plate having excellent chemical resistance and that has excellent removability of engraving residue, a relief printing plate precursor using the resin composition for laser engraving, a process for making a relief printing plate using the precursor, and a relief printing plate obtained thereby.

### Means for Solving the Problems

The above-mentioned object of the present invention has been achieved by means described in <1>, <12> to <15> and <18> below. They are described below together with <2> to <11>, <16> and <17>, which are preferred embodiments.

<1> A resin composition for laser engraving, comprising (Component A) a filler having an ethylenically unsaturated group, (Component B) a polymerizable compound having an ethylenically unsaturated group, and (Component C) a polymerization initiator,
<2> the resin composition for laser engraving according to <1> above, wherein Component A is an inorganic filler having an ethylenically unsaturated group,
<3> the resin composition for laser engraving according to <2> above, wherein the inorganic filler has a spherical form,
<4> the resin composition for laser engraving according to <2> above, wherein the inorganic filler has a layered form,
<5> the resin composition for laser engraving according to <2> or <3> above, wherein the inorganic filler is carbon black,
<6> the resin composition for laser engraving according to <2> or <3> above, wherein the inorganic filler is silica,
<7> the resin composition for laser engraving according to <2> or <4> above, wherein the inorganic filler is mica,
<8> the resin composition for laser engraving according to any one of <1> to
<7> above, wherein Component C is a thermal polymerization initiator,
<9> the resin composition for laser engraving according to any one of <1> to
<8> above, wherein the composition further comprises (Component D) a binder polymer,
<10> the resin composition for laser engraving according to any one of <1> to
<9> above, wherein the composition further comprises (Component E) a plasticizer,
<11> the resin composition for laser engraving according to any one of <1> to
<10> above, wherein the composition further comprises (Component F) at least one oxy compound of metals and metalloids selected from Groups I to XVI of the periodic table,
<12> a relief printing plate precursor for laser engraving, comprising a relief-forming layer comprising the resin composition for laser engraving according to any one of <1> to <11> above,
<13> a relief printing plate precursor for laser engraving, comprising a crosslinked relief-forming layer formed by thermally crosslinking the relief-forming layer comprising the resin composition for laser engraving according to any one of <1> to <11> above,
<14> a process for producing a relief printing plate precursor, comprising a layer formation step of forming a relief-forming layer comprising the resin composition for laser engraving according to any one of <1> to <11> above, and a crosslinking step of crosslinking the relief-forming layer by means of light and/or heat to thus obtain a relief printing plate precursor having a crosslinked relief-forming layer,
<15> a process for making a relief printing plate, comprising a layer formation step of forming a relief-forming layer comprising the resin composition for laser engraving according to any one of <1> to <11> above, a crosslinking step of crosslinking the relief-forming layer by light and/or heat to thus obtain a relief printing plate precursor having a crosslinked relief-forming layer, and an engraving step of laser engraving the relief printing plate precursor having a crosslinked relief-forming layer to thus form a relief layer,
<16> the process for making a relief printing plate according to <15> above, wherein the laser engraving is performed by means of a laser of 700 to 1,300 nm,
<17> the process for making a relief printing plate according to <15> or <16> above, wherein the process further comprises a cleaning step of cleaning the surface of the relief layer after the engraving by means of water or an aqueous solution,
<18> a relief printing plate, comprising a relief layer made by the process for making a relief printing plate according to any one of <15> to <17> above.

### MODE FOR CARRYING OUT THE INVENTION

Hereinafter, the present invention is explained in detail.

Meanwhile, in the present invention, the description of “the upper limit to the lower limit” denoting the numerical range denotes “not less than the lower limit but not more than the upper limit,” and “the upper limit to the lower limit” denotes “not more than the upper limit but not less than the lower limit.” That is, it denotes the numerical range that includes the upper and lower limits. Further, “(Component A) a filler having an ethylenically unsaturated group” etc. are simply called “Component A” etc.

### (Resin Composition for Laser Engraving)

The resin composition for laser engraving of the present invention (hereinafter, also simply called the “resin composition”) is characterized by comprising (Component A) a filler having an ethylenically unsaturated group, (Component B) a polymerizable compound having an ethylenically unsaturated group, and (Component C) a polymerization initiator.

The resin composition for laser engraving of the present invention may widely be applied to other applications without particular limitations, in addition to the application of the relief-forming layer of a relief printing plate precursor to be subjected to laser engraving. For example, it may be applied not only to the relief-forming layer of a printing plate precursor that is subjected to raised relief formation by laser engraving, which will be described in detail below, but also to the formation of other products in which asperities or openings are formed on the surface, for example, various printing plates and various formed bodies in which images are formed by laser engraving such as an intaglio plate, a stencil plate and a stamp.

Among these, a preferable embodiment is to apply it to the formation of a relief-forming layer provided over an appropriate support.

In the present specification, with regard to the explanation of the relief printing plate precursor, a crosslinkable layer that has a layer having a flat surface and is not crosslinkded as a image-forming layer to be provided for laser engraving is called a relief-forming layer, a layer formed by crosslinking the relief-forming layer is called a crosslinked relief-forming layer, and a layer that has been subjected to laser engraving to thus form asperities on the surface is called a relief layer.

Constituent components of the resin composition for laser engraving are explained below.

### <(Component A) a Filler Having an Ethylenically Unsaturated Group>

The resin composition for laser engraving of the present invention comprises (Component A) a filler having an ethylenically unsaturated group.

The description of “having an ethylenically unsaturated group” in Component A denotes either a group or a compound having an ethylenically unsaturated group is physically adsorbed to the filler, or it is further bonded chemically.

With regard to methods showing that the filler has an ethylenically unsaturated group, checking methods below are preferably exemplified.

To 10 g of a filler or a filler dispersion, 100 g of methyl ethyl ketone is added, which is stirred at 25° C. for 30 min and then filtrated to remove the methyl ethyl ketone. The obtained solid is used to form a tablet (having a height of 500 μm and a diameter of 2 mm) mixed with KBr so as to give 50 times weight. Next, the absorbance at a wave number of 810 cm⁻¹ derived from a C═C double bond is measured with a FT-IR measurement apparatus (FTS-7000, Varian Technologies Japan), and, from the presence of a C═C double bond, it is confirmed that the filler has an ethylenically unsaturated group.

Moreover, a method is also exemplified, in which the FT-IR measurement is performed by the same method as described above before and after acting a known compound that reacts with an ethylenically unsaturated group to a filler or a filler dispersion to thus convert the ethylenically unsaturated group to another functional group, and, from the change of the peak in spectra before and after the conversion, the presence of the ethylenically unsaturated group is confirmed.

As a method for separating the filler from the resin composition, filtration etc. may be exemplified. When performing the filtration, if necessary, the viscosity may be adjusted by a solvent.

The filler in the present invention is not particularly limited, only if it does not molecularly disperses in the resin composition but disperses in a solid state.

Fillers used in the present invention include organic fillers and inorganic fillers.

Examples of the organic fillers include low density polyethylene particles, high density polyethylene particles, polystyrene particles, various organic pigments, micro balloons, urea-formalin fillers, polyester particles, cellulose fillers, organic metals, etc.

As organic pigments, known ones are cited, including indigo-based pigment, quinacridone-based pigment, dioxazine-based pigment, isoindolinone-based pigment, quinophthalone-based pigment, dyed lake pigment, azine pigment, nitroso pigment, nitro pigment, natural pigment, fluorescent pigment, etc. An inorganic pigment may be contained.

Examples of the inorganic fillers include alumina, titania, zirconia, kaolin, calcined kaolin, talc, pagodite, diatomite, calcium carbonate, aluminum hydroxide, magnesium hydroxide, zinc oxide, lithopone, amorphous silica, colloidal silica, calcined gypsum, silica, magnesium carbonate, titanium oxide, alumina, barium carbonate, barium sulfate, mica, carbon black, etc.

Among these, carbon black, silica, alumina and mica are preferable, carbon black, silica and mica are more preferable, and carbon black and silica are particularly preferable.

The form of the filler used in the present invention is not particularly limited, but a spherical form, a layered form, a fibrous form and a hollow balloon form may be cited. Among these, a spherical form and a layered form are preferable, and a spherical form is more preferable.

An average particle diameter (average primary particle diameter) of fillers used in the present invention is preferably 10 nm to 10 μm, more preferably 10 nm to 5 μm, and particularly preferably 50 nm to 3 μm. The diameter in the above-mentioned range makes the stability of the resin composition good, and can suppress the generation of film omission after engraving to thus make the image quality excellent.

As carbon black, only if there is no such problem as dispersion instability in the resin composition constituting the relief-forming layer, any of carbon blacks usually used for various applications such as coloring, rubber and dry battery is used, in addition to products falling within standards classified by ASTM.

The carbon black cited here also includes, for example, furnace black, thermal black, channel black, lampblack, acetylene black, etc. Black colorants such as carbon black can be used for the preparation of the resin composition as a color chip or a color paste previously dispersed in nitrocellulose or a binder, while using a dispersing agent if necessary for making the dispersion easy. Such chips and pastes can easily be obtained as commercial products.

In the present invention, it is also possible to use carbon blacks having a relatively low specific surface area and relatively low DBP absorption, and microfabricated carbon blacks having a large specific surface area.

Examples of the favorable commercial products of carbon black include Printex U (registered trade mark), Printex A (registered trade mark) and Spezialschwarz 4 (registered trade mark) (all are manufactured by Degussa), SEAST 600 ISAF-LS (Tokai Carbon Co., Ltd.), Asahi #70 (N-300) (ASAHI CARBON CO., LTD.), KETJEN BLACK EC600JD (Lion Corporation), etc.

With regard to the selection of such carbon blacks, for example, “Carbon Black Handbook” edited by Carbon Black Association may be referred to.

The carbon black has preferably a spherical form. With regard to a primary particle diameter, greater than 20 nm but less than 80 nm is preferable, and greater than 25 nm but less than 70 nm is more preferable. Carbon blacks falling within the range can suppress aggregation and are excellent in dispersibility.

As fillers of a layered form, inorganic compounds of a layered form having a thin flat plate shape is favorably cited, and examples thereof include mica groups such as natural mica and synthesized mica denoted by Formula below, talc denoted by 3MgO.4SiO.H₂O, taeniolite, montmorillonite, saponite, hectolite, zirconium phosphate, etc.

A(B,C)_{2 to 5}D₄O₁₀(OH,F,O)₂

wherein A denotes any of K, Na and Ca, B and C denote any of Fe(II), Fe(III), Mn, Al, Mg and V, and D denotes Si or Al.

With regard to the shape of inorganic layered compounds used in the present invention, an aspect ratio is preferably 20 or more, more preferably 100 or more, and particularly preferably 200 or more. The aspect ratio is a ratio of a major diameter relative to the thickness of a particle, and, for example, can be measured from a projection view by an electron microphotograph of a particle. The greater the aspect ratio, the greater the effect to be obtained.

With regard to the particle diameter of inorganic layered compounds used in the present invention, the average major diameter is preferably 0.3 to 20 μm, more preferably 0.5 to 10 μm, and particularly preferably 1 to 5 μm. The average thickness of the particle is preferably 0.1 μm or less, more preferably 0.05 μm or less, and particularly preferably 0.01 μm or less.

For example, among inorganic layered compounds, the size of swellable synthetic mica that is a representative compound is 1 to 50 nm in thickness, and the surface size is around 1 to 20 μm. As mica particles used in the present invention, synthetic mica (“Somashif ME-100”, aspect ratio: 1,000 or greater, Co-op Chemical Co., Ltd.) can be exemplified.

As silica used in the present invention, spherical silica particles are preferable, and commercial products shown below are exemplified preferably. Numerals in parentheses denote the average particle diameter.

Specific examples of products by EVONIK INDUSTRIES include AEROSIL RM50 (40 nm), R711 (12 nm), R7200 (12 nm), AEROSIL OX50 (40 nm), 50 (30 nm), 90G (20 nm), 130 (16 nm), 150 (14 nm), 200 (12 nm), 200 CF (12 nm), 300 (7 nm) and 380 (7 nm).

Specific examples of products by AGC Si-Tech. Co., Ltd. include SUNSPHERE H-31 (3 μm), H-51 (5 μm), H-121 (12 μm), H-201 (20 μm), SUNSPHERE L-31 (3 μm), L-51 (5 μm), SUNSPHERE NP-30 (4 μm), NP-100 (10 μm) and NP-200 (20 μm).

Specific examples of products by Nissan Chemical Industries, Ltd. include methanol silica sol (10 to 20 nm), MA-ST-M (10 to 20 nm), IPA-ST (10 to 20 nm), EG-ST (10 to 20 nm), EG-ST-ZL (70 to 100 nm), NPC-ST (10 to 20 nm), DMAC-ST (10 to 20 nm), MEK-ST (10 to 20 nm), XBA-ST (10 to 20 nm) and MIBK-ST (10 to 20 nm).

### <Physical Adsorption or Chemical Bond of Ethylenically Unsaturated Group or Ethylenically Unsaturated Compound to Filler>

In Component A used in the present invention, an ethylenically unsaturated group or a compound having an ethylenically unsaturated group may be physically adsorbed or bonded by a chemical bond to the filler.

Moreover, Component A used in the present invention preferably has an ethylenically unsaturated group on the surface of the filler.

The method for introducing an ethylenically unsaturated group onto the filler is not particularly limited, and examples of such methods include methods described in “Kinzoku Sekken no Seishitsu to Oyo (Nature and Application of Metal Soaps)” (SAIWAI SHOBO), “Insatsu Ink Gijutsu (Printing Ink Technology)” (CMC Publishing CO., LTD., published in 1984), or “Saishin Ganryo Oyo Gijutsu (Newest Application Technology of Pigments)” CMC Publishing CO., LTD., published in 1986).

With regard to a method for chemically bonding a compound having an ethylenically unsaturated group to the filler, a method in which a compound reactive to the filler is reacted with the filler to thus introduce an ethylenically unsaturated group is cited. The compound reactive with the filler may or may not have an ethylenically unsaturated group. When a compound that is reactive with the filler and has no ethylenically unsaturated group is used, for example, it is sufficient to introduce an ethylenically unsaturated group into the functional group introduced into the filler by means of the compound reactive with the filler.

Specifically, for example, modifying an inorganic particle such as a silica particle with a silane coupling agent is cited.

Examples of the silane coupling agents include vinyltrichlorosilane, vinyltrimethoxysilane, vinyltriethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, and p-styryltrimethoxysilane.

As a method for causing a compound having an ethylenically unsaturated group to be absorbed physically to the filler, there are cited such methods as dispersing the filler in a low molecular component having an ethylenically unsaturated group, using a polymer having an ethylenically unsaturated group as a dispersing agent of the filler, etc. Among these, from the viewpoint of dispersibility of the filler, the method of using a polymer having an ethylenically unsaturated group as a dispersing agent is particularly preferable. That is, the resin composition of the present invention particularly preferably contains the filler having a polymer having an ethylenically unsaturated group on the surface thereof.

As the polymer having an ethylenically unsaturated group, any compound that has an ethylenically unsaturated group in the molecule and is a polymer may be used without particular limitation. For example, copolymers having a constitutional unit having an ethylenically unsaturated group are cited.

In polymers having an ethylenically unsaturated group, a monomer unit having an ethylenically unsaturated group is preferably 10 to 90 mol % relative to all monomer units, more preferably 30 to 70 mol %, and most preferably 45 to 70 mol %.

The weight average molecular weight (Mw) of polymers having an ethylenically unsaturated group is 1,000 or more, preferably 2,000 to 200,000, and more preferably 4,000 to 120,000.

Examples of the ethylenically unsaturated groups include, for example, an allyl group, a cinnamyl group, a crotyl group, a styryl group, an acryloyl group, a methacryloyl group, etc.

The ethylenically unsaturated group may be contained in a main chain of the polymer, or in a side chain. The ethylenically unsaturated group may be introduced in polymers without particular limitations. It may be introduced by copolymerization, or by a polymer reaction.

### Monomer Unit Having Ethylenically Unsaturated Group

The polymer having an ethylenically unsaturated group preferably has a monomer unit having an ethylenically unsaturated group.

Examples of the methods for introducing a monomer unit having an ethylenically unsaturated group to thus form the polymer having an ethylenically unsaturated group include a method of copolymerizing an ethylenically unsaturated compound of two or more functionalities, a method of copolymerizing a monomer having such reactive group as a carboxyl group, a hydroxy group or the like and introducing an ethylenically unsaturated group to the reactive group by a polymer reaction, and a method of copolymerizing a monomer having a precursor group of an ethylenically unsaturated group and modifying the precursor group of an ethylenically unsaturated group to the ethylenically unsaturated group. Among these, the method of copolymerizing a monomer having a reactive group and introducing an ethylenically unsaturated group to the reactive group by a polymer reaction is preferable.

In the present invention, the monomer unit to which an ethylenically unsaturated group has been introduced by a polymer reaction means the whole one monomer unit including the structure introduced to the original monomer unit by the polymer reaction.

Examples of the monomers having a reactive group include (meth)acrylic acid, 2-hydroxyethyl(meth)acrylate, 2-hydroxypropyl (meth)acrylate, 3-hydroxypropyl(meth)acrylate, 4-hydroxybutyl(meth)acrylate, hydroxystyrene, vinylbenzoic acid, etc.

In the present invention, “(meth)acrylate” means “acrylate and/or methacrylate,” and “(meth)acrylic” means “acrylic and/or methacrylic.”

Specific examples of the polymer reactions include a polymer reaction of reacting an ethylenically unsaturated compound having a hydroxy group such as 2-hydroxypropyl(meth)acrylate to a carboxyl group in a polymer, a polymer reaction of reacting a carboxylic halide having an ethylenically unsaturated group such as (meth)acrylic chloride, or a carboxylic acid having an ethylenically unsaturated group such as (meth)acrylic acid to a hydroxy group in a polymer, etc.

In the method of copolymerizing an ethylenically unsaturated compound of two or more functionalities, as the ethylenically unsaturated compound of two or more functionalities, polyfunctional ethylenically unsaturated compounds having two or more ethylenically unsaturated groups different in polymerization properties are preferably cited. The different polymerization properties of the ethylenically unsaturated groups in the polyfunctional ethylenically unsaturated compound make it easy to leave an ethylenically unsaturated group having low polymerization properties, even when polymerization is performed, in the polymer after the polymerization.

Examples of the polyfunctional ethylenically unsaturated compounds having two or more kinds of ethylenically unsaturated groups different in polymerization properties include compounds having an allyl group and a (meth)acrylic group, and a compound having a styryl group and a (meth)acrylic group. Specific examples thereof include allyl(meth)acrylate and 4-styryl (meth)acrylate.

### Polymerizable Oligomer Having Ethylenically Unsaturated Croup at Terminal

The polymer having an ethylenically unsaturated group is preferably a polymer obtained by copolymerizing a polymerizable oligomer having an ethylenically unsaturated group at a terminal (hereinafter, also called a “macromonomer”) as a copolymerization component.

The polymerizable oligomer (macromonomer) having an ethylenically unsaturated group at a terminal comprises a polymer chain part and a part of an ethylenically unsaturated group at the terminal thereof.

It is preferable that the macromonomer has the ethylenically unsaturated group at only one terminal (hereinafter, also called a “single terminal”) of the polymer.

With regard to the molecular weight of the polymerizable oligomer having an ethylenically unsaturated group at a terminal, the number average molecular weight (Mn) on a polystyrene basis is preferably 1,000 to 20,000, and more preferably 2,000 to 10,000. When it falls within the range, it can hold a sufficient steric repulsion effect as a dispersing agent for the filler.

In the polymerizable oligomer having an ethylenically unsaturated group at a terminal, the polymer chain part is preferably a homopolymer or a copolymer formed from at least one monomer selected from the group consisting of alkyl(meth)acrylate, styrene, acrylonitrile, vinyl acetate and butadiene. Among these, a homopolymer or a copolymer of alkyl (meth)acrylate, or polystyrene is favorably cited.

In the polymerizable oligomer having an ethylenically unsaturated group at a terminal, as the ethylenically unsaturated group, a (meth)acryloyl group and a vinyl group are preferable, and a (meth)acryloyl group is particularly preferable.

In the present invention, the polymerizable oligomer having an ethylenically unsaturated group at a terminal may have a substituent. The substituent is not particularly limited, and examples of the substituent include a halogen atom etc.

Specific preferable examples of the polymerizable oligomers having an ethylenically unsaturated group at a terminal include favorably polymers in which a (meth)acryloyl group is bonded at a single terminal of the molecule, such as polystyrene, polymethyl(meth)acrylate, poly-n-butyl(meth)acrylate and poly-i-butyl(meth)acrylate.

The polymerizable oligomer having an ethylenically unsaturated group at a terminal may be a commercial product, or a suitably synthesized one.

Examples of the commercial products include a single terminal methacryloylated polystyrene oligomer (Mn=6,000, trade name: AS-6, TOAGOSEI CO., LTD.), a single terminal methacryloylated polymethyl methacrylate oligomer (Mn=6,000, trade name: AA-6, TOAGOSEI CO., LTD.), a single terminal methacryloylated poly-n-butyl acrylate oligomer (Mn=6,000, trade name: AB-6, TOAGOSEI CO., LTD.), etc.

Examples of the latter include a single terminal methacryloylated methyl (meth)acrylate copolymer, a single terminal methacryloylated styrene copolymer, a single terminal methacryloylated n-butyl(meth)acrylate copolymer, a single terminal methacryloylated methyl(meth)acrylate and hydroxyethyl(meth)acrylate copolymer, a single terminal methacryloylated n-butyl(meth)acrylate and hydroxyethyl(meth)acrylate copolymer, a single terminal methacryloylated 2-ethylhexyl(meth)acrylate and hydroxyethyl (meth)acrylate copolymer, a single terminal methacryloylated styrene and acrylonitrile copolymer, a single terminal methacryloylated ethylene glycol copolymer, a single terminal methacryloylated propylene glycol copolymer, a single terminal methacryloylated ε-caprolactone copolymer, etc.

### Monomer Unit Having Adsorption Site

The polymer having an ethylenically unsaturated group preferably has a monomer unit having an adsorption site.

The adsorption site is a site capable of being adsorbed physically to the filler used.

As the adsorption site, a nitrogen-containing heterocyclic group is preferable.

Examples of the preferable nitrogen-containing heterocyclic groups include groups obtained by removing one or more hydrogen atoms from the ring selected from the group consisting of a pyridine ring, an imidazoline ring, a pyrazoline ring, an imidazole ring, a pyrimidine ring, a triazole ring, a tetrazole ring, a thiazole ring, an oxazole ring, a benzimidazole ring, a benzothiazole ring, a benzoxazole ring, a purine ring, a quinazoline ring and a perimidin ring.

The nitrogen-containing heterocyclic group may have a substituent, and examples of the substituents include a halogen atom, a carboxyl group, a carbonyloxy group, an alkoxy group, a hydroxy group, an amino group, an amide group, a mercapto group, an alkylthio group, etc.

As the monomer forming the monomer unit having an adsorption site, a monomer denoted by Formula (Ad-1) below is preferable.

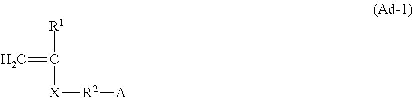

wherein R¹ denotes a hydrogen atom or a substituted or unsubstituted alkyl group, R² denotes a single bond or a divalent linking group, X denotes —CO—, —C(═O)O—, —CONH—, —OC(═O)— or a phenylene group, and A denotes a substituted or unsubstituted nitrogen-containing heterocyclic group.

In Formula (Ad-1) above, R¹ denotes a hydrogen atom, or a substituted or unsubstituted alkyl group. Examples of the alkyl groups include a methyl group, an ethyl group, a phenyl group, a benzyl group, etc. Among these, a methyl group is preferable. The alkyl group may have a substituent, and examples of the substituents include favorably a halogen atom (chlorine atom, bromine atom, etc.), a carboxyl group, a carbonyloxy group, an alkoxy group, an alkylthio group, etc. Among these, a halogen atom is preferable.

In Formula (Ad-1) above, R² denotes a single bond or a divalent linking group. As the divalent linking group, it denotes a substituted or unsubstituted alkylene group having 1 to 12 carbon atoms that may be bonded via a hetero atom, including, for example, a methylene group, an ethylene group, a trimethylene group, a tetramethylene group, a hexamethylene group, —CH₂CH₂O—, —CH₂CH₂OCH₂CH₂O—, —(CH₂)₃—O—(CH₂)₃O—, etc. Among these, from the viewpoint of functioning as a so-called spacer when a nitrogen-containing heterocyclic group is introduced, which is to be described later, an ethylene group, a trimethylene group and —CH₂CH₂O— are preferable.

In Formula (Ad-1) above, X denotes —CO—, —C(═O)O—, —CONH—, —OC(═O)— or a phenylene group. Among these, —C(═O)O—, —CONH— or a phenylene group is preferable.

In Formula (Ad-1) above, A denotes a substituted or unsubstituted nitrogen-containing heterocyclic group. A is preferably a group selected from the group consisting of a substituted or unsubstituted pyridyl group, imidazolyl group, pyrazolyl group, triazolyl group and tetrazolyl group. The nitrogen-containing heterocyclic group may have a substituent, and examples of the substituents include a halogen atom, a carboxyl group, a carbonyloxy group, an alkoxy group, a hydroxy group, an amino group, an amide group, a mercapto group, an alkylthio group, etc. The nitrogen-containing heterocyclic group is excellent as an adsorbing group, and is used preferably from the viewpoint of enhancing the dispersibility of the filler. Moreover, by introducing the nitrogen-containing heterocyclic group via the aforementioned R² that functions as a spacer, the effect on the dispersibility of the filler is furthermore enhanced.

The following are specific examples of preferable monomers (monomer 1 to monomer 18) denoted by Formula (Ad-1) above, but the present invention is not limited to these specific examples.

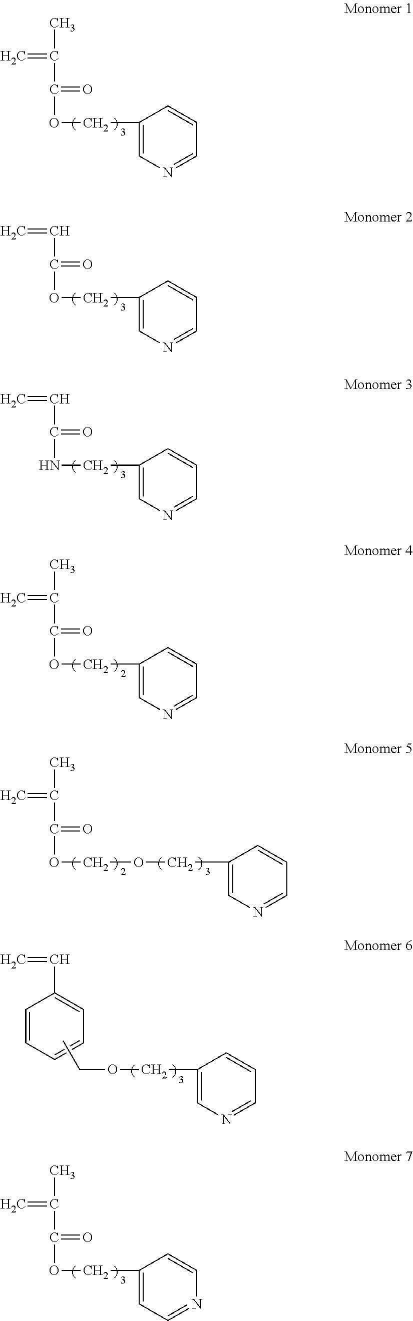

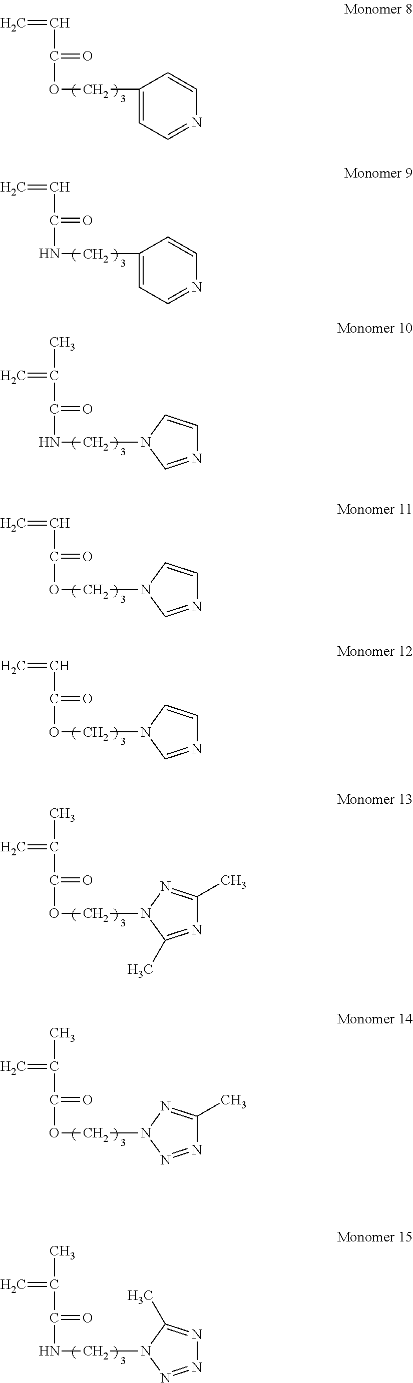

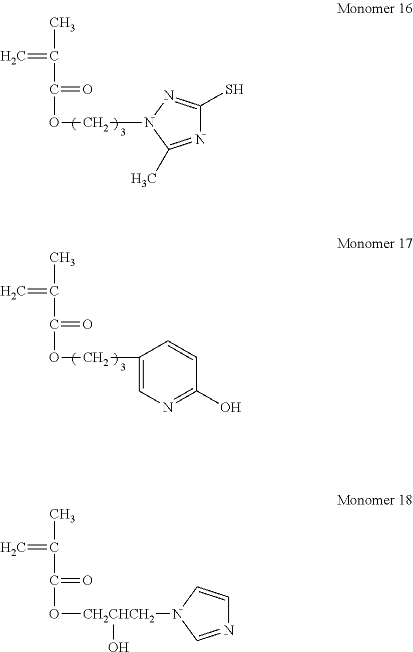

The polymer having an ethylenically unsaturated group contains preferably a copolymer obtained by copolymerizing at least one kind of monomers denoted by Formula (Ad-1) above.

That is, the polymer having an ethylenically unsaturated group has preferably at least a monomer unit denoted by Formula (Ad-1′) below.

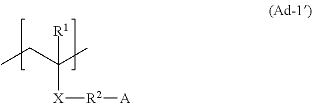

R¹, R², X and A in Formula (Ad-1′) have the same meaning as R¹, R², X and A in Formula (Ad-1) above, and preferable embodiments are also the same.

In the polymer having an ethylenically unsaturated group, the monomer unit denoted by Formula (Ad-1′) above may be incorporated in one kind alone, or incorporated in two or more kinds.

The content of the monomer unit denoted by Formula (Ad-1′) above in the polymer having an ethylenically unsaturated group is incorporated preferably in the ratio of 3 to 70 wt % relative to the total weight of the polymer, more preferably 5 to 50 wt %, and particularly preferably 10 to 40 wt %. When the ratio falls within the above-mentioned range, the aggregation of the filler is suppressed and the filler has an excellent dispersibility.

As a monomer that forms the monomer unit having the adsorption site, monomers denoted by Formula (Ad-2) below are preferable.

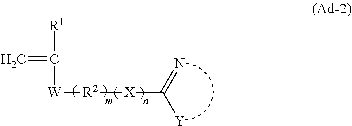

wherein R¹ denotes a hydrogen atom, or a substituted or unsubstituted alkyl group, R² denotes an alkylene group, W denotes —CO—, —C(═O)O—, —CONH—, —OC(═O)— or a phenylene group, X denotes —O—, —S—, —C(═O)O—, —CONH—, —C(═O)S—, —NHCONH—, —NHC(═O)O—, —NHC(═O)S—, —OC(═O)—, —OCONH— or —NHCO—, Y denotes —NR³—, —O—, —S— or —N═ and forms a ring structure by being linked with a nitrogen atom via an atomic group adjacent to it, R³ denotes a hydrogen atom, an alkyl group or an aryl group, and each of m and n denotes independently 0 or 1.

R¹ in Formula (Ad-2) denotes a hydrogen atom or a substituted or unsubstituted alkyl group.

As the alkyl group denoted by R¹, an alkyl group having 1 to 12 carbon atoms is preferable, an alkyl group having 1 to 8 carbon atoms is more preferable, and an alkyl group having 1 to 4 carbon atoms is particularly preferable.

When the alkyl group denoted by R¹ is a substituted alkyl group, examples of introducible substituents include a hydroxy group, an alkoxy group, an aryloxy group, an acyloxy group, a halogen group, etc.

Specific examples of preferable alkyl groups denoted by R¹ include a methyl group, an ethyl group, a n-propyl group, an i-propyl group, a n-butyl group, an i-butyl group, a t-butyl group, a n-hexyl group, a cyclohexyl group, a 2-hydroxyethyl group, a 3-hydroxypropyl group, a 2-hydroxypropyl group, a 2-methoxyethyl group, etc.

As R¹, a hydrogen atom or an alkyl group having 1 to 4 carbon atoms is particularly preferable.

R² in Formula (Ad-2) denotes an alkylene group.

As the alkylene group denoted by R², an alkylene group having 1 to 12 carbon atoms is preferable, an alkylene group having 1 to 8 carbon atoms is more preferable, and an alkylene group having 1 to 4 carbon atoms is particularly preferable.

The alkylene group denoted by R² may have a substituent, if introducible, and examples of the substituents include a hydroxy group, an alkoxy group, an aryloxy group, an acyloxy group, etc.

Specific examples of the preferable alkylene groups denoted by R² include a methylene group, an ethylene group, a propylene group, a trimethylene group, a tetramethylene group, etc.

W denotes —CO—, —C(═O)O—, —CONH—, —OC(═O)— or a phenylene group, wherein —C(═O)O—, —CONH— or a phenylene group is preferable.

Y denotes —NR³—, —O—, —S— or —N═, and forms a ring structure by being bonded with a N atom via an atomic group adjacent to it.

R³ denotes a hydrogen atom, an alkyl group or an aryl group. As the alkyl group denoted by R³, an alkyl group having 1 to 12 carbon atoms, etc. are favorably cited, and, as the aryl group denoted by R³, a phenyl group, a naphthyl group, etc. are favorably cited.

R³ is more preferably a hydrogen atom or an alkyl group having 1 to 4 carbon atoms, and particularly preferably a hydrogen atom or a methyl group.

Y is particularly preferably —S—, —NH— or —N═.

Examples of the ring structures that Y forms by being linked with a N atom via an atomic group adjacent to it include single ring structures such as an imidazole ring, a pyrimidine ring, a triazole ring, a tetrazole ring, a thiazole ring and an oxazole ring, and condensed ring structures such as a benzimidazole ring, a benzothiazole ring, a benzoxazole ring, a purine ring, a quinazoline ring and a perimidin ring. From the viewpoint of the affinity with the filler, the condensed ring structure is preferable. Among the condensed ring structures, a benzimidazole ring, a benzothiazole ring and a benzoxazole ring are particularly preferably cited.

X denotes —O—, —S—, —C(═O)O—, —CONH—, —C(═O)S—, —NHCONH—, —NHC(═O)O—, —NHC(═O)S—, —OC(═O)—, —OCONH— or —NHCO—. As X, —O—, —S—, —CONH—, —NHCONH— or —NHC(═O)S— is particularly preferable.

Each of m and n denotes independently 0 or 1, and a case where both m and n are 1 is particularly preferable.

The following are specific examples of the preferable monomers (Monomer M-1 to Monomer M-18) denoted by Formula (Ad-2) above. But the present invention is not limited to these.

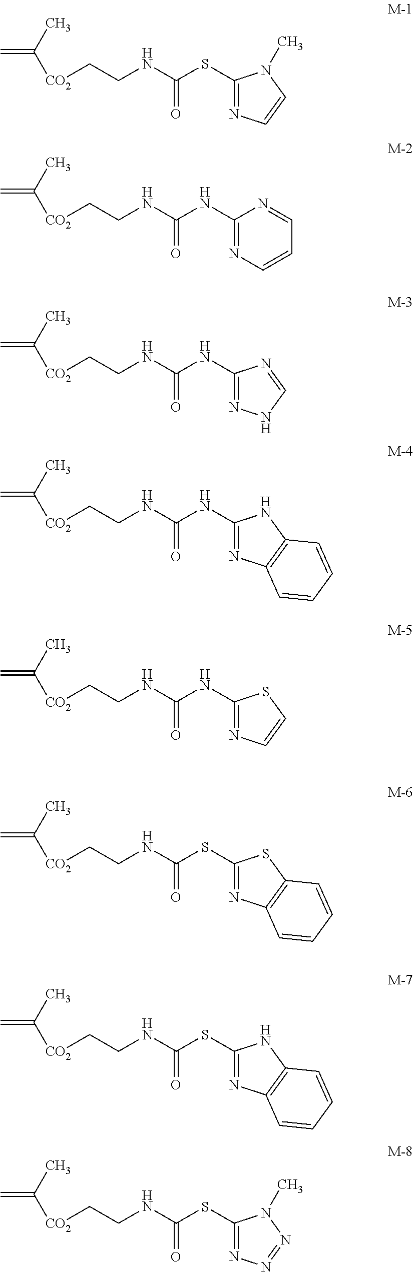

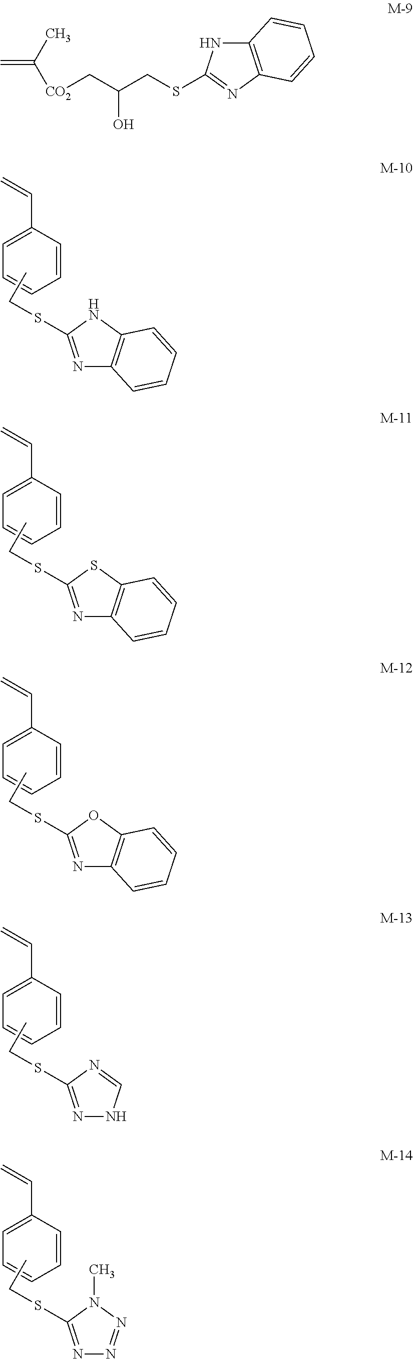

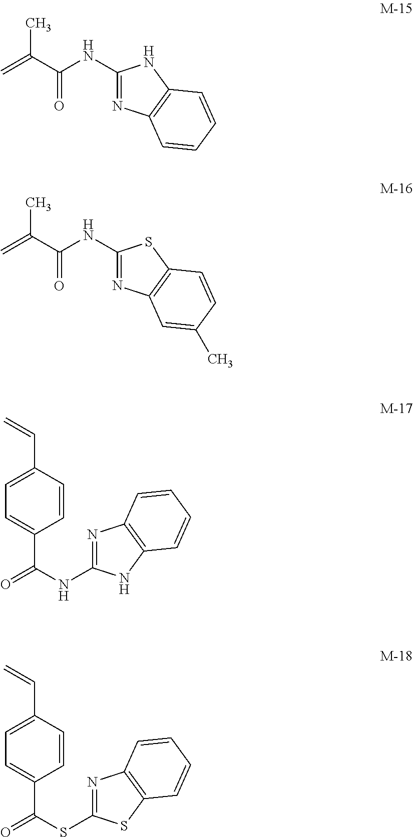

The polymer having an ethylenically unsaturated group contains preferably a copolymer formed by copolymerizing at least one kind of monomers denoted by Formula (Ad-2) above.

That is, the polymer having an ethylenically unsaturated group has preferably at least a monomer unit denoted by Formula (Ad-2′) below.

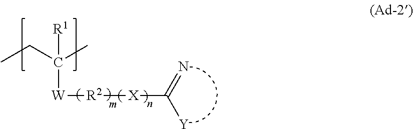

R¹, R², W, X, Y, m and n in Formula (Ad-2′) have the same meaning as those of R¹, R², W, X, Y, m and n in Formula (Ad-2) above, and preferred embodiments are also the same.

In the polymer having an ethylenically unsaturated group, the monomer unit denoted by Formula (Ad-2′) above may be contained in one kind alone, or in two or more kinds.

The content of the monomer unit denoted by Formula (Ad-2′) above in the polymer having an ethylenically unsaturated group is preferably 2 to 50 wt % relative to the total weight of the polymer.

### Other Copolymers

The polymer having an ethylenically unsaturated group may furthermore contain copolymerizable monomers other than monomers described above as a copolymerization component in a range that does not deteriorate the effect thereof.

The monomers used in the present invention is not particularly limited, and preferable examples of the monomers used in the present invention include (meth)acrylic esters, crotonic esters, vinyl esters, maleic diesters, fumaric diesters, itaconic diesters, (meth)acrylamides, vinyl ethers, vinyl alcohol esters, styrenes, (meth)acrylonitrile, etc.

The following compounds are specific examples of such monomers.

Examples of (meth)acrylic esters include methyl(meth)acrylate, ethyl(meth)acrylate, n-propyl(meth)acrylate, isopropyl(meth)acrylate, n-butyl(meth)acrylate, isobutyl(meth)acrylate, t-butyl(meth)acrylate, n-hexyl(meth)acrylate, cyclohexyl(meth)acrylate, t-butylcyclohexyl(meth)acrylate, 2-ethylhexyl(meth)acrylate, t-octyl(meth)acrylate, dodecyl(meth)acrylate, octadecyl(meth)acrylate, acetoxyethyl(meth)acrylate, phenyl(meth)acrylate, 2-hydroxyethyl(meth)acrylate, 2-methoxyethyl(meth)acrylate, 2-ethoxyethyl(meth)acrylate, 2-(2-methoxyethoxy)ethyl(meth)acrylate, 3-phenoxy-2-hydroxypropyl(meth)acrylate, benzyl(meth)acrylate, diethylene glycol monomethyl ether(meth)acrylate, diethylene glycol monoethyl ether (meth)acrylate, triethylene glycol monomethyl ether(meth)acrylate, triethylene glycol monoethyl ether(meth)acrylate, polyethylene glycol monomethyl ether(meth)acrylate, polyethylene glycol monoethyl ether(meth)acrylate, β-phenoxyethoxyethyl(meth)acrylate, nonylphenoxypolyethylene glycol (meth)acrylate, dicyclopentenyl(meth)acrylate, dicyclopentenyloxyethyl (meth)acrylate, trifluoroethyl(meth)acrylate, octafluoropentyl(meth)acrylate, perfluorooctylethyl(meth)acrylate, dicyclopentanyl(meth)acrylate, tribromophenyl(meth)acrylate, tribromophenyloxyethyl(meth)acrylate, etc.

Examples of crotonic esters include butyl crotonate, hexyl crotonate, etc.

Examples of vinyl esters include vinyl acetate, vinyl propionate, vinyl butyrate, vinyl methoxyacetate, vinyl benzoate, etc.

Examples of maleic diesters include dimethyl maleate, diethyl maleate, dibutyl maleate, etc.

Examples of fumaric diesters include dimethyl fumarate, diethyl fumarate, dibutyl fumarate, etc.

Examples of itaconic diesters include dimethyl itaconate, diethyl itaconate, dibutyl itaconate, etc.

Examples of (meth)acrylamides include (meth)acrylamide, N-methyl(meth)acrylamide, N-ethyl(meth)acrylamide, N-propyl(meth)acrylamide, N-isopropyl(meth)acrylamide, N-n-butyl(meth)acrylamide, N-t-butyl(meth)acrylamide, N-cyclohexyl(meth)acrylamide, N-(2-methoxyethyl)(meth)acrylamide, N,N-dimethyl(meth)acrylamide, N,N-diethyl(meth)acrylamide, N-phenyl(meth)acrylamide, N-benzyl(meth)acrylamide, (meth)acryloyl morpholine, diacetoneacrylamide, etc.

Examples of styrenes include styrene, methylstyrene, dimethylstyrene, trimethylstyrene, ethylstyrene, isopropylstyrene, butylstyrene, hydroxystyrene, methoxystyrene, butoxystyrene, acetoxystyrene, chlorostyrene, dichlorostyrene, bromostyrene, chloromethylstyrene, hydroxystyrene protected by a group capable of being deprotected by an acidic material (such as a t-Boc group (t-butoxycarbonyl group)), methyl vinylbenzoate, α-methylstyrene, etc.

Examples of vinyl ethers include methyl vinyl ether, butyl vinyl ether, hexyl vinyl ether, methoxyethyl vinyl ether, etc.

The following are specific examples of polymers B-1 to B-15 having an ethylenically unsaturated group preferably used in the present invention, but the present invention is not limited to these.

| | Component 1 | | Component 2 | | Component 3 | |
|---|---|---|---|---|---|---|
| | Structure | wt % | Structure | wt % | Structure | wt % |
| B-1 | Single terminal methacryloylated polymethyl methacrylate (Mn: 6,000) | 30 | 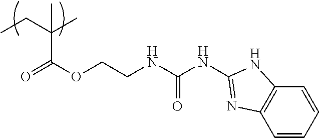 | 20 | 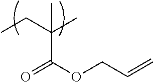 | 50 |
| B-2 | Single terminal methacryloylated polymethyl methacrylate (Mn: 6,000) | 30 | 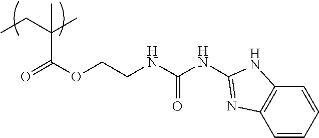 | 20 | 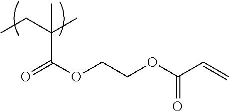 | 50 |
| B-3 | Single terminal methacryloylated polymethyl methacrylate (Mn: 6,000) | 30 | 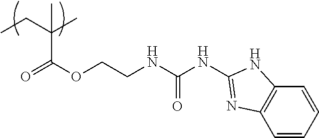 | 20 | 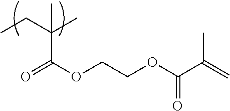 | 50 |
| B-4 | Single terminal methacryloylated polymethyl methacrylate (Mn: 6,000) | 30 | 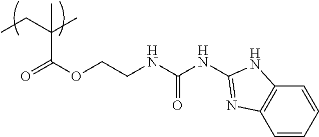 | 20 | 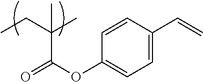 | 50 |
| B-5 | Single terminal methacryloylated polymethyl methacrylate (Mn: 6,000) | 30 | 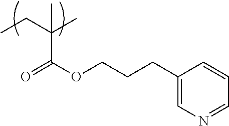 | 20 | 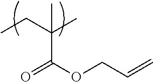 | 50 |
| B-6 | Single terminal methacryloylated polymethyl methacrylate (Mn: 6,000) | 30 | 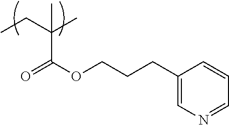 | 20 | 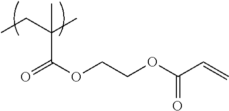 | 50 |
| B-7 | Single terminal methacryloylated polymethyl methacrylate (Mn: 6,000) | 30 | 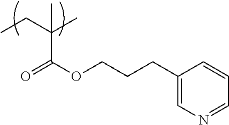 | 20 | 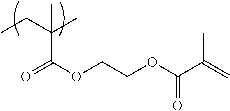 | 50 |
| B-8 | Single terminal methacryloylated polymethyl methacrylate (Mn: 6,000) | 30 | 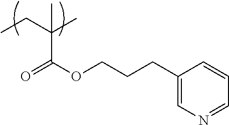 | 20 | 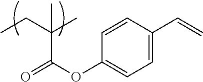 | 50 |
| B-9 | Single terminal methacryloylated polymethyl methacrylate (Mn: 6,000) | 30 | 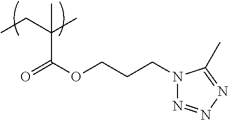 | 20 | 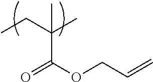 | 50 |
| B-10 | Single terminal methacryloylated polymethyl methacrylate (Mn: 6,000) | 30 | 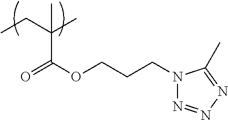 | 20 | 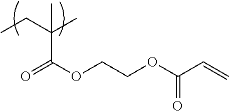 | 50 |
| B-11 | Single terminal methacryloylated polymethyl methacrylate (Mn: 6,000) | 30 | 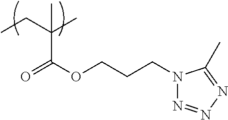 | 20 | 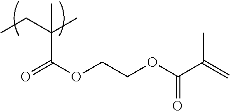 | 50 |
| B-12 | Single terminal methacryloylated polymethyl methacrylate (Mn: 6,000) | 30 | 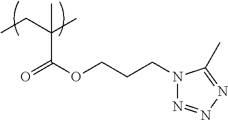 | 20 | 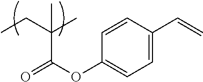 | 50 |
| B-13 | Single terminal methacryloylated polymethyl methacrylate (Mn: 6,000) | 30 | 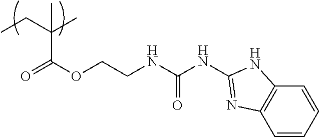 | 20 | 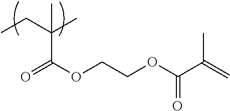 | 50 |
| B-14 | Single terminal methacryloylated polymethyl methacrylate (Mn: 6,000) | 30 | 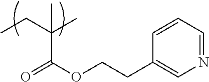 | 20 | 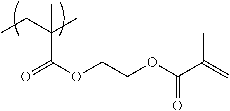 | 50 |
| B-15 | Single terminal methacryloylated polymethyl methacrylate (Mn: 6,000) | 30 | 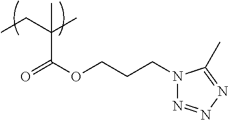 | 20 | 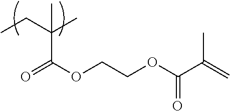 | 50 |

### Method for Dispersing Filler

As a method for surface-treating the filler with a compound having an ethylenically unsaturated group, known dispersion technologies employed for manufacturing an ink, manufacturing a toner, etc. may be used. Examples of the dispersing machines include an ultrasonic dispersion apparatus, a sand mill, an attriter, a pearl mill, a super mill, a ball mill, an impeller, a disperser, a KD mill, a colloid mill, a dynatron, a three roll mill, a pressurized kneader, etc. Details are described in “Saishin Ganryo Oyo Gijutsu (Newest Application Technology of Pigments)” CMC Publishing CO., LTD., published in 1986).

A polymer may be added for improving the dispersion stability of the filler used in the present invention. Examples of the polymers (so-called dispersing agents) include polyvinyl alcohol, acrylamide/acrylic acid copolymer, styrene/maleic anhydride copolymer, sodium polyacrylate, sodium alginate, etc.

The addition amount of (Component A) a filler having an ethylenically unsaturated group in the resin composition for laser engraving of the present invention is, relative to the total solids content (amount excluding the solvent) of the resin composition, preferably 1 to 20 wt %, more preferably 3 to 15 wt %, and particularly preferably 5 to 10 wt %. When it falls within the range, engraving residue-removing properties and chemical resistance are excellent, and it is possible to suppress that the end portion of an image part and a non-image part becomes particulate to thus give an excellent image quality. When a dispersing agent such as the polymer having an ethylenically unsaturated group is employed, the total amount of the filler and the dispersing agent falls preferably within the above-mentioned addition amount.

### <(Component B) a Polymerizable Compound Having an Ethylenically Unsaturated Group>

The resin composition for laser engraving of the present invention contains (Component B) a polymerizable compound having an ethylenically unsaturated group.

The polymerizable compound having an ethylenically unsaturated group (also called an “ethylenically unsaturated compound”) employable for the present invention may arbitrarily be selected from compounds having at least one ethylenically unsaturated group, preferably two or more groups, and more preferably 2 to 6 groups.

Further, the polymerizable compound having an ethylenically unsaturated group employable for the present invention is preferably a compound having two or more (meth)acrylic groups, and more preferably is a compound having two or more (meth)acryloxy groups.

Hereinafter, monofunctional monomers having one ethylenically unsaturated group, and polyfunctional monomers having two or more ethylenically unsaturated groups employed as the polymerizable compound having an ethylenically unsaturated group are explained.

In the resin composition of the present invention, polyfunctional monomers are preferably used in order to form a crosslinked structure in the film. The polyfunctional monomer has preferably a molecular weight of 200 to 2,000.

Examples of the monofunctional monomers include esters of an unsaturated carboxylic acid (such as acrylic acid, methacrylic acid, itaconic acid, crotonic acid, isocrotonic acid or maleic acid) with a monovalent alcohol compound, amides of an unsaturated carboxylic acid with a monovalent amine compound, etc. Examples of the polyfunctional monomers include esters of an unsaturated carboxylic acid (such as acrylic acid, methacrylic acid, itaconic acid, crotonic acid, isocrotonic acid or maleic acid) with a polyvalent alcohol compound, amides of an unsaturated carboxylic acid with a polyvalent amine compound, etc.

Further, addition products of an unsaturated carboxylic acid ester or amide having a nucleophilic substituent such as a hydroxy group, an amino group or a mercapto group with a monofunctional or polyfunctional isocyanate or epoxy, dehydrating condensation products with a monofunctional or polyfunctional carboxylic acid, etc. are used preferably.

Examples of the polyfunctional monomers include esters of an unsaturated carboxylic acid and a polyvalent aliphatic alcohol.

Specific examples of them include, as acrylic acid esters, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of methacrylic acid esters include tetramethylene glycol Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

As examples of other esters, aliphatic alcohol-based esters described in JP-B-46-27926, JP-B-51-47334 (JP-B denotes a Japanese examined patent application publication) and JP-A-57-196231, those having an aromatic skeleton described in JP-A-59-5240, JP-A-59-5241, and JP-A-2-226149, those having an amino group described in JP-A-1-165613, etc. may also be used suitably.

Furthermore, specific examples of amide monomers of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based polyfunctional ethylenically unsaturated compounds include those having a cyclohexylene structure described in JP-B-54-21726.

Furthermore, a urethane-based addition-polymerizable compound produced by an addition reaction of an isocyanate group and a hydroxy group is also suitable as a polyfunctional ethylenically unsaturated compound, and specific examples thereof include urethane-based polyfunctional ethylenically unsaturated compounds comprising two or more groups per molecule in which a hydroxy group-containing ethylenically unsaturated compound represented by Formula (A) below is added to a polyisocyanate compound having two or more isocyanate groups per molecule described in JP-B-48-41708.

CH₂═C(R)COOCH₂CH(R)OH (A)

wherein R and R′ independently denote H or CH₃.

Furthermore, urethane acrylates described in JP-A-51-37193, JP-B-2-32293, and JP-B-2-16765, and urethane-based polyfunctional ethylenically unsaturated compounds having an ethylene oxide chain described in JP-B-58-49860, JP-B-56-17654, JP-B-62-39417, JP-B-62-39418 are also suitable.

Furthermore, by use of an addition-polymerizable compound having an amino structure or a sulfide structure in the molecule described in JP-A-63-277653, JP-A-63-260909, and JP-A-1-105238, a crosslinked resin composition can be obtained in a short time.

Other examples of polyfunctional ethylenically unsaturated compounds include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Specific examples of a radical polymerizable compound employable for the present invention include saturated bridged cyclic polyfunctional monomers.

As the saturated bridged cyclic polyfunctional monomer, the use of an alicyclic polyfunctional monomer having a condensed ring structure such as a compound having a bicyclo ring or a tricyclo ring structure having two methacryloyloxy groups or acryloyloxy groups is preferable from the viewpoint of controlling the physical properties.

Examples of the bicyclo rings or tricyclo rings include alicyclic hydrocarbon structures of a condensed ring structure such as norbornene skeleton (bicyclo[2.2.1]heptane), dicyclopentadiene skeleton (tricyclo[5.2.1.0^{2,6}]decane), adamantine skeleton (tricyclo[3.3.1.1^{3,7}]decane).

As the saturated bridged cyclic polyfunctional monomer, an amino group may be bonded to a bicyclo ring or a tricyclo ring directly, or via a aliphatic part of alkylene etc. such as methylene or ethylene. Moreover, a hydrogen atom of an alicyclic hydrocarbon group of these condensed ring structures may be substituted by an alkyl group etc.

In the present invention, the saturated bridged cyclic polyfunctional monomer is preferably an alicyclic polyfunctional monomer selected from the compounds below.

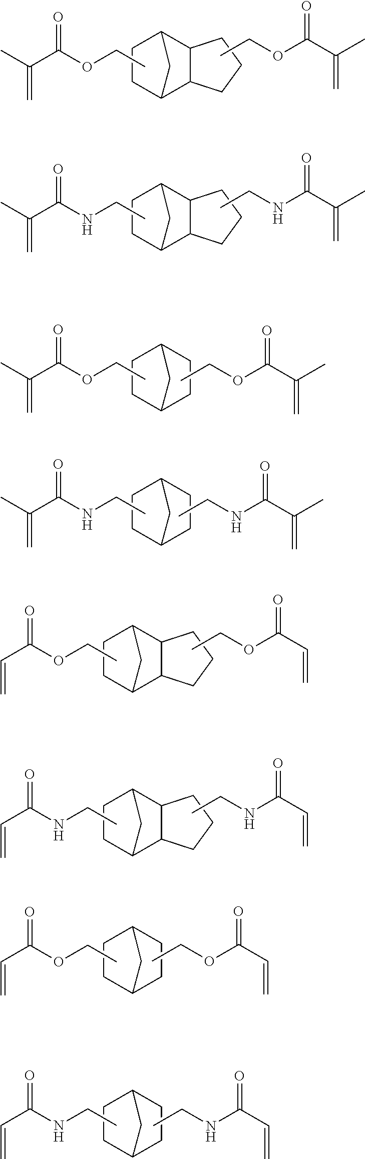

Further, as the polymerizable compound having an ethylenically unsaturated group, addition products of unsaturated carboxylic acid esters or amides having an electrophilic substituent such as an isocyanate group or an epoxy group with a monofunctional or polyfunctional alcohol, amine or thiol, and substitution products of unsaturated carboxylic acid esters or amides having a leaving substituent such as a halogeno group or a tosyloxy group with a monofunctional or polyfunctional alcohol, amine or thiol are also preferable.

In addition, as other examples, the use of compounds obtained by substituting the unsaturated carboxylic acid by an unsaturated sulfonic acid, styrene, a vinyl ether or the like is also possible.

The polymerizable compound having an ethylenically unsaturated group is not particularly limited, and, in addition to compounds exemplified above, various known compounds may be used. For example, compounds described in JP-A-2009-204962, paragraphs 0098 to 0124 may be used.

From the viewpoint of improving engraving sensitivity, it is preferable in the present invention to use as the polymerizable compound having an ethylenically unsaturated group a compound having a sulfur atom in the molecule.

As such an ethylenically unsaturated compound having a sulfur atom in the molecule, it is preferable from the viewpoint of improving engraving sensitivity in particular to use a polymerizable compound having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably at least one unit selected from —C—S—, —C—S—S—, —NHC(═S)O—, —NHC(═O)S—, —NHC(═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

Moreover, examples of the polymerizable compound having a sulfur atom in the molecule include those described in paragraphs 0032 to 0037 of JP-A-2009-255510.

Component B in the resin composition of the present invention may be used singly or in a combination of two or more compounds.

The content of Component B contained in the resin composition of the present invention is preferably 2 to 50 wt % on a solids content basis, more preferably is 5 to 30 wt %, and most preferably is 10 to 20 wt %.

### <(Component C) Polymerization Initiator>

The resin composition for laser engraving of the present invention comprises (Component C) polymerization initiator.

With regard to the polymerization initiator, one known to a person skilled in the art may be used without any limitations, but is preferably a radical polymerization initiator.

Radical polymerization initiators, which are preferred polymerization initiators, are explained in detail below, but the present invention should not be construed as being limited to these descriptions.

A radical polymerization initiator may be a radical photopolymerization initiator or a radical thermopolymerization initiator, but preferably is a radical thermopolymerization initiator.

In the present invention, preferred examples of the radical polymerization initiator include (a) an aromatic ketone, (b) an onium salt compound, (c) an organic peroxide, (d) a thio compound, (e) a hexaarylbiimidazole compound, (f) a ketoxime ester compound, (g) a borate compound, (h) an azinium compound, (i) a metallocene compound, (j) an active ester compound, (k) a compound having a carbon halogen bond, and (l) an azo-based compound.

Specific examples of the (a) to (l) above are shown below, but the present invention is not limited to these.

In the present invention, (c) an organic peroxide and (l) an azo-based compound is preferable, and (c) an organic peroxide is particurally preferable from the viewpoint of improving the engraving sensitivity and rerief edge shape when it is applied to the relief-forming layer in the relief printing plate precursor.

As compound comprises before-mentioned (a) aromatic ketones, (b) onium salt compounds, (d) a thio compound, (e) hexaarylbiimidazole compounds, (f) a ketoxime ester compound, (g) a borate compound, (h) an azinium compound, (i) metallocene compounds, (j) an active ester compound, (k) compounds having a carbon-halogen bond, the compounds described in JP-A-2008-63554, paragraphs 0074 to 0118 can preferably be used.

Examples of (c) organic peroxides and (l) azo-based compounds include compounds as shown below.

Preferable (c) organic peroxides as the radical polymerization initiator which can be used in the present invention is prederably ether peoxide such as 3,3′,4,4′-tetra(tertiarybutylperoxycarbonyl)benzophenone, 3,3′,4,4′-tetra(tertiaryamylperoxycarbonyl)benzophenone, 3,3′,4,4′-tetra(tertiaryhexylperoxycarbonyl)benzophenone, 3,3′,4,4′-tetra(tertiaryoctylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-tertiarybutyldiperoxy isophthalate etc.

### (l) Azo-Based Compound

Preferable (l) azo-based compounds used as the radical polymerization initiator in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethyl azobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

In the present invention, the above-mentioned (c) organic peroxide is preferable as the polymerization initiator in the present invention from the viewpoint of the crosslinking properties of the film (relief-forming layer), and particularly preferable from the viewpoint of improving the engraving sensitivity.

From the viewpoint of the engraving sensitivity, an embodiment obtained by combining (c) an organic peroxide and a polymer having a glass transition temperature of ordinary temperature (20° C.) or more as (Component D) a binder polymer is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the radiated laser energy to thus raise the engraving sensitivity.

It is presumed that, in the case where the glass transition temperature of the binder polymer is ordinary temperature (20° C.) or more, the heat generated caused by the decomposition of the organic peroxide is transmitted effectively to the binder polymer and utilized effectively to the thermal decomposition of the binder polymer itself to thus make the sensitivity more higher.

It will be described in detail in the explanation of a light-heat converting agent, the effect thereof is remarkable when carbon black is used as the light-heat converting agent. It is considered that the heat generated from the carbon black is also transmitted to (c) an organic peroxide and, as the result, heat is generated not only from the carbon black but also from the organic peroxide, and that the generation of heat energy to be used for the decomposition of the binder polymer etc. occurs synergistically.

Further, as a component to be preferably combined, the use of the organic peroxide and the light-heat converting agent to be described later in combination causes the engraving sensitivity to be raised extremely, more preferably, and an embodiment that uses the organic peroxide and carbon black as the light-heat converting agent in combination is most preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, an energy of generated heat is added to the radiated laser energy to thus raise the engraving sensitivity.

Component C in the present invention may be used singly or in a combination of two or more compounds.

The content of Component C in the resin composition of the present invention is preferably 0.1 to 5 wt % relative to the total weight of the solids content, more preferably 0.3 to 3 wt %, particularly preferably 0.5 to 1.5 wt %.

### <(Component D) a Binder Polymer>

A resin composition for raser engraving of the present invention preferably comprises (Component D) a binder polymer.

A binder polymer is a polymer component contained in resin composition for raser engraving.

The number-average molecular weight (Mn) of the binder polymer is preferably 500 to 5,000,000.

The weight-average molecular weight (In polystyrene equivalent by GPC mesurement) of the binder polymer is preferably less than 1,000, more preferably is 5,000 to 5,000,000, yet more preferably is 10,000 to 4,000,000, and particularly preferably is 150,000 to 3,000,000.

Examples of binder is a polystyrene resin, polyester resin, polyamide resin, polyurea resin, polyamide imide resin, polyurethane resin, polysulfone resin, polyether sulfone resin, polyimide resin, polycarbonate resin, hydroxyethylene unit-containing hydrophilic polymer, acrylic resin, acetal resin, epoxy resin, polycarbonate resin, rubber, thermoplastic elastomer, etc.

A binder polymer used in the present invention is preferably binder polymer having a group having hydroxyl group, alkoxyl group, hydrolyzable silyl group and/or a silanol group.

The functional group may be present in any part of the polymer molecule, but particularly preferably lies on the side chain of the chain polymer. As such polymers, vinyl copolymers (copolymers of vinyl monomers such as polyvinyl alcohol and polyvinyl acetal, and derivatives thereof) and acrylic resins (copolymers of acrylic monomers such as hydroxyethyl(meth)acrylate, and derivatives thereof) may be preferably used. A derivative of a copolymer of vinyl monomers specifically denotes a binder polymer extended a side chain by a chemical modification at hydroxy group or α-position of hydroxy group of vinyl alcohol unit and introduced a functional group such as hydroxy group or carboxy group at a terminal thereof.

### Binder Polymer Having a Hydroxyl Group

Hereinafter, a binder polymer having a hydroxyl group (hereinafter, appropriately also referred to as a “specific polymer”) will be explained. This binder polymer is preferably insoluble in water and soluble in alcohol having 1 to 4 carbon atoms.

As specific polymer, from the view point of satisfying both good durability properties for an aqueous ink and for a UV ink, and having a high engraving sensitivity and good film performance, polyvinyl butyral (PVB) and derivatives thereof, acrylic resins having a hydroxyl group on a side chain, epoxy resins having a hydroxyl group on a side chain, etc. are preferable.

A specific polymer used in the present invention is particularly preferable for improvement of engraving sensitivity when combined with a photothermal conversion agent descrived below at a glass transition temperature (Tg) of at least 20° C.

A binder polymer having such a glass transition temperature is also called a non-elastomer below. That is, generally, an elastomer is academically defined as a polymer having a glass transition temperature of no greater than 20° C. (room temperature) (ref. Kagaku Dai Jiten 2^{nd} edition (Science Dictionary), Foundation for Advancement of International Science, Maruzen, P. 154). Non-elastomer refers to a polymer which a glass transition temperature of greater than room temperature. The upper limit for the glass transition temperature of the polymer is not limited, but is preferably no greater than 200° C. from the viewpoint of ease of handling, and is more preferably at least 25° C. but no greater than 120° C.

When a polymer having a glass transition temperature of room temperature (20° C.) or greater is used, a specific polymer is in a glass state at normal temperature. Because of this, compared with a case of the rubber state, thermal molecular motion is suppressed. In laser engraving, in addition to the heat given by a laser during laser irradiation, heat generated by the function of a photothermal conversion agent added as desired is transmitted to the surrounding specific polymer, and this polymer is thermally decomposed and disappears, thereby forming an engraved recess.

In preferred mode of the present invention, it is surmised that when a photothermal conversion agent is present in a state in which thermal molecular motion of a specific polymer is suppressed, heat transfer to and thermal decomposition of the specific polymer occur effectively. It is anticipated that such an effect further increases the engraving sensitivity.

Specific examples of polymers that are non-elastomer for use preferably in the present invention are cited below.

### (1) Polyvinyl Acetal and its Derivative

In this description, hereinafter, polyvinyl acetal and derivatives thereof are called just a polyvinyl acetal derivative. That is, a polyvinyl acetal derivative includes polyvinyl acetal and derivatives thereof, and is a generic term used to refer to compounds obtained by converting polyvinyl alcohol (obtained by saponifying polyvinyl acetate) into a cyclic acetal.

The acetal content in the polyvinyl acetal derivative (mole % of vinyl alcohol units converted into acetal relative to the total number of moles of vinyl acetate monomer starting material as 100 mol %) is preferably 30 to 90 mol %, more preferably 50 to 85 mol %, and particularly preferably 55 to 78 mol %.

The vinyl alcohol unit in the polyvinyl acetal is preferably 10 to 70 mol % relative to the total number of moles of the vinyl acetate monomer starting material, more preferably 15 to 50 mol %, and particularly preferably 22 to 45 mol %.

Furthermore, the polyvinyl acetal may have a vinyl acetate unit as another component, and the content thereof is preferably 0.01 to 20 mol %, and more preferably 0.1 to 10 mol %. The polyvinyl acetal derivative may further have another copolymerized constitutional unit.

Examples of the polyvinyl acetal derivative include a polyvinyl butyral derivative, a polyvinyl propylal derivative, a polyvinyl ethylal derivative, and a polyvinyl methylal derivative. Among them, a polyvinyl butyral derivative (hereinafter, it is also referred to as a “PVB derivative”) is a derivative that is preferable. In this description, for examples, a polyvinyl butyral derivative includes polyvinyl butyral and derivatives thereof, and the same can be said for other polyvinyl acetal derivatives.

From the viewpoint of a balance being achieved between engraving sensitivity and film formation properties, the weight-average molecular weight of the polyvinyl acetal derivative is preferably 5,000 to 800,000, more preferably 8,000 to 500,000 and, from the viewpoint of improvement of rinsing properties for engraving residue, particularly preferably 50,000 to 300,000.

Preferable examples of a polyvinyl butyral derivative are cited for explanation, but there are not limited to these.

An example of structure of polyvinyl butyral derivatives is shown below, and is constituted while including these constitutional units. L is preferably more than 50 mol %.

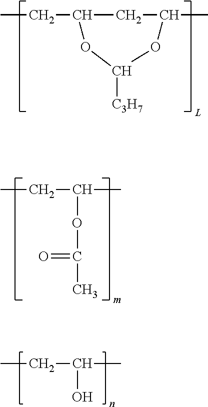

Derivatives of PVB are available as a commercial product. As specific examples, from the viewpoint of alcohol (in particular, ethanol) solubility, “Eslec B” series and “Eslec K (KS)” series (Sekisui Chemical Co., Ltd.) and “Denka Butyral” (Denki Kagaku Kogyo K.K.) are preferable, and, from the viewpoint of alcohol (in particular, ethanol) solubility, “Eslec B” series (Sekisui Chemical Co., Ltd.) and “Denka Butyral” (Denki Kagaku Kogyo K.K.) are more preferable.

Among these, particularly preferable commercial products are shown below with values of L, m and n in Formula above and molecular weight. With regard to “Eslec B” series (Sekisui Chemical Co., Ltd.), “BL-1” (L=61, m=3, n=36, weight average molecular weight: 19,000), “BL-1H” (L=67, m=3, n=30, weight average molecular weight: 20,000), “BL-2” (L=61, m=3, n=36, weight average molecular weight: about 27,000), “BL-5” (L=75, m=4, n=21, weight average molecular weight: 32,000), “BL-S” (L=74, m=4, n=22, weight average molecular weight: 23,000), “BM-S” (L=73, m=5, n=22, weight average molecular weight: 53,000), “BH-S” (L=73, m=5, n=22, weight average molecular weight: 66,000) are cited. With regard to “Denka Butyral” series (Denki Kagaku Kogyo K.K.), “#3000-1” (L=71, m=1, n=28, weight average molecular weight: 74,000), “#3000-2” (L=71, m=1, n=28, weight average molecular weight: 90,000), “#3000-4” (L=71, m=1, n=28, weight average molecular weight: 117,000), “#4000-2” (L=71, m=1, n=28, weight average molecular weight: 152,000), “#6000-C” (L=64, m=1, n=35, weight average molecular weight: 308,000), “#6000-EP” (L=56, m=15, n=29, weight average molecular weight: 381,000), “#6000-CS” (L=74, m=1, n=25, weight average molecular weight: 322,000), “#6000-AS” (L=73, m=1, n=26, weight average molecular weight: 242,000) are cited.

When the relief-forming layer is formed using PVB as the specific polymer, a method of casting and drying a solution prepared by solving it in a solvent is preferable from the viewpoint of the flatness of the film surface.

### (2) An Acrylic Resin

As binder polymer, an acrylic resin may be used.

As acrylic resin, acrylic resin having hygroxy group is preferable.

Preferable examples of the acrylic monomer having a hydroxy group include a (meth)acrylic acid ester, a crotonic acid ester, or a (meth)acrylamide that has a hydroxy group in the molecule. Specific examples of such a monomer include 2-hydroxyethyl(meth)acrylate, 2-hydroxypropyl(meth)acrylate, and 4-hydroxybutyl(meth)acrylate.

As acrylic resin, the acrylic monomer other than that having hydroxy group may comprises as a co-monomer. Examples thereof such an acrylic monomer include, as the (meth)acrylic ester, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-hexyl(meth)acrylate, 2-ethylhexyl(meth)acrylate, acetoxyethyl(meth)acrylate, phenyl(meth)acrylate, 2-methoxyethyl(meth)acrylate, 2-ethoxyethyl(meth)acrylate, 2-(2-methoxyethoxy)ethyl(meth)acrylate, cyclohexyl(meth)acrylate, benzyl(meth)acrylate, diethylene glycol monomethyl ether(meth)acrylate, diethylene glycol monoethyl ether(meth)acrylate, diethylene glycol monophenyl ether(meth)acrylate, triethylene glycol monomethyl ether(meth)acrylate, triethylene glycol monoethyl ether(meth)acrylate, dipropylene glycol monomethyl ether(meth)acrylate, polyethylene glycol monomethyl ether(meth)acrylate, polypropylene glycol monomethyl ether(meth)acrylate, the monomethyl ether(meth)acrylate of a copolymer of ethylene glycol and propylene glycol, N,N-dimethylaminoethyl(meth)acrylate, N,N-diethylaminoethyl(meth)acrylate, and N,N-dimethylaminopropyl(meth)acrylate.

Furthermore, a modified acrylic resin formed with a urethane group- or urea group-containing acrylic monomer may preferably be used.

Among these, from the viewpoint of aqueous ink resistance, an alkyl(meth)acrylate such as lauryl(meth)acrylate and an aliphatic cyclic structure-containing (meth)acrylate such as t-butylcyclohexyl(meth)acrylate are particularly preferable.

Furthermore, as the specific polymer, a novolac resin may be used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin between a mixture of phenol/cresol (any of m-, p-, o- or m-/p-, m-/o-, o-/p-mixtures) and formaldehyde.

With regard to these novolac resins, those having a weight-average molecular weight of 800 to 200,000 and a number-average molecular weight of 400 to 60,000 are preferable.

An epoxy resin having a hydroxy group in a side chain may be used as a specific polymer. A preferred example of the epoxy resin is an epoxy resin formed by polymerization, as a starting material monomer, of an adduct of bisphenol A and epichlorohydrin. The epoxy resin preferably has a weight-average molecular weight of at least 800 but no greater than 200,000, and a number-average molecular weight of at least 400 but no greater than 60,000.

Among specific polymers, polyvinyl butyral derivatives are particularly preferable from the viewpoint of rinsing properties and printing durability when the polymer is formed into the relief-forming layer.

In polymers of any embodiment described above, the content of the hydroxyl group contained in the specific polymer in the present invention is preferably 0.1 to 15 mmol/g, and more preferably 0.5 to 7 mmol/g.

Component D in the resin composition of the present invention may be used only in one kind, or in two or more kinds in combination.

The content of Component D in the resin composition of the present invention is preferably 10 to 50 wt % relative to the total weight of the solids content of the resin composition, more preferably 15 to 45 wt %, and particularly preferably 20 to 40 wt %.

### <(Component E) a Plasticizer>

The resin composition of the present invention contains preferably (Component E) a plasticizer from the viewpoint of giving flexibility necessary as a flexographic printing plate.

As the plasticizer, ones known as a plasticizer for polymer may be employed. Examples thereof include, although not limited, adipic acid derivatives, azelaic acid derivatives, benzoyl acid derivatives, citric acid derivatives, epoxy derivatives, glycol derivatives, hydrocarbons and derivatives, oleic acid derivatives, phosphoric acid derivatives, phthalic acid derivatives, polyester-based materials, ricinoleic acid derivatives, sebacic acid derivatives, stearic acid derivatives, sulfonic acid derivatives, terpene and derivatives and trimellitic acid derivatives, as described in “Kobunshi Daijiten (Comprehensive Dictionary of Polymers)” (first edition, 1994, Maruzen) pages 211 to 220. Among these, from the viewpoint of a large effect of lowering the glass transition temperature, adipic acid derivatives, citric acid derivatives and phosphoric acid derivatives are preferable, and phosphoric acid derivatives are more preferable.

As the adipic acid derivatives, dibutyl adipate and 2-butoxyethyl adipate are preferable.

As the citric acid derivatives, tributyl citrate is preferable.

Examples of the phosphoric acid derivatives include tributyl phosphate, tri-2-ethylhexyl phosphate, tributoxyethyl phosphate, triphenyl phosphate, cresyldiphenyl phosphate, tricresyl phosphate, t-butylphenyl phosphate, 2-ethylhexyldiphenyl phosphate, etc. Among these, triphenyl phosphate, cresyldiphenyl phosphate and tricresyl phosphate are preferable, and cresyldiphenyl phosphate is more preferable.

Component E may be used in one kind alone, or in two or more kinds in combination.

From the viewpoint of lowering the glass transition temperature to room temperature or less, the content of Component E is, on a solid content basis while defining the total weight of the resin composition as 100 wt %, preferably 1 to 50 wt %, more preferably 10 to 40 wt %, and yet more preferably 20 to 30 wt %.

<(Component F) at Least One Oxy Compound of Metals and Metalloids (Semimetals) Selected from Groups I to XVI of the Periodic Table>

The resin composition of the present invention contains preferably (Component F) at least one oxy compound of metals and metalloids (semimetals) selected from Groups I to XVI of the periodic table.

Metals and metalloids selected from Groups I to XVI of the periodic table is not particularly limited, only if they are selected from Groups I to XVI of the periodic table. Preferable examples thereof include alkali metals (Li, Na, K, Rb, Cs, Fr), alkali earth metals (Be, Mg, Ca, Sr, Ba, Ra), aluminum, silicon, phosphorous, titanium, germanium, arsenic, zirconium, tin, zinc, cadmium, bismuth, indium, scandium and antimony.

Among these, from the viewpoint of the engraving sensitivity, alkali earth metals, aluminum, silicon, phosphorous, titanium, germanium, arsenic, zirconium, tin, zinc and bismuth are preferable, alkali earth metals, aluminum, titanium (preferably having valency of 4), zirconium, tin, zinc and bismuth are more preferable, and alkali earth metals, aluminum, titanium (preferably having valency of 4), tin, zinc and bismuth are particularly preferable.

Examples of the oxy compounds (oxygen-containing compounds) include alkoxides, phenoxides, enolates, carbonates, acetates, carboxylates and oxides of the metals and metalloids.

If desired, a part of the organic part of the oxy compound may be polyvalent, that is, for example, may be one derived from polyhydric alcohol (such as glycol or glycerol), polyvinyl alcohol or hydroxycarboxylic acid. A chelate compound may also be used. When a carbon atom exists, the number of carbon atoms per one metal or metalloid is preferably in a range of 4 to 24.

In the present invention, a carboxylate of aluminum, zinc, tin or bismuth is preferable, and a carboxylate of zinc is more preferable.

Specifically, zinc acetate, zinc 2-ethylhexylate, tin 2-ethylhexylate, bismuth tris(2-ethylhexanoate), hydroxyaluminum bis(2-ethylhexylate) are particularly preferable, and zinc 2-ethylhexylate is most preferable.

From the viewpoint of the engraving sensitivity and coating properties, the content of Component F is preferably 0.01 to 20 wt % relative to the total solids content of the resin composition, more preferably 0.5 to 10 wt %, and yet more preferably 1 to 5 wt %.

### <(Component G) Solvent>

A solvent is preferably used when preparing the resin composition for laser engraving of the present invention. As a solvent, an organic solvent is preferable.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among them, propylene glycol monomethyl ether acetate is particularly preferable.

The amount of a solvent used is not limited, may be adjust as necessary.

### <Other Additives>

The resin composition for laser engraving of the present invention may comprise as appropriate various types of known additives as long as the effects of the present invention are not inhibited. Examples include a filler, a wax, a process oil, an a metal oxide, an antiozonant, an anti-aging agent, a thermopolymerization inhibitor, and a colorant, and one type thereof may be used on its own or two more types may be used in combination.

A compound having a hydrolyzable silyl group and/or a silanol group may be also used as other component.

Specific examples of a compound having a hydrolyzable silyl group and/or a silanol group include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane, trimethylsilanol, diphenylsilanediol, triphenylsilanol, methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

### (Relief Printing Plate Precursor for Laser Engraving)

A first embodiment of the relief printing plate precursor for laser engraving of the present invention comprises a relief-forming layer formed from the resin composition for laser engraving of the present invention.

A second embodiment of the relief printing plate precursor for laser engraving of the present invention comprises a crosslinked relief-forming layer formed by crosslinking a relief-forming layer formed from the resin composition for laser engraving of the present invention.

In the present invention, the ‘relief printing plate precursor for laser engraving’ means both or one of a relief printing plate precursor having a crosslinkable relief-forming layer formed from the resin composition for laser engraving in a state before being crosslinked and a relief printing plate precursor in a state in which it is cured by light or heat.

A relief printing plate precursor for laser engraving of the present invention preferably comprises a crosslinked relief-forming layer formed by thermally crosslinking.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking is preferably performed by light and/or heat. Moreover, the crosslinking is not limited only if it is a reaction that cures the resin composition, and is a general idea that includes the crosslinked structure by the reaction of ethylenically unsaturated compounds of Component B with each other, Component A with Component B, and the reaction of Components A with each other, the crosslinked structure is preferably formed by the reaction of Component A with Component B, the reaction of Components B with each other.

The ‘relief printing plate’ is made by laser engraving printing prcursor having crosslinked relief-forming layer.

In the present invention, the ‘relief layer’ means layer engraved by laser in relief printing plate, that is, the crosslinked relief-forming layer after laser engraving.

A relief printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) relief printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention, and is a crosslinkable layer.

As a mode in which a relief printing plate is prepared using the relief printing plate precursor for laser engraving, a mode in which a relief printing plate is prepared by crosslinking a relief-forming layer to thus form a relief printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an Example below.

### <Support>

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### <Process for Producing Relief Printing Plate Precursor for Laser Engraving>

Formation of a relief-forming layer in the relief printing plate precursor for laser engraving is not particularly limited, and examples thereof include a method in which a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a relief printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a relief printing plate precursor having a crosslinked relief-forming layer, is more preferably a production process comprising a layer formation step of forming a relief-forming layer from the resin composition for laser engraving of the present invention a crosslinking step of crosslinking the relief-forming layer by means of heat to thus obtain a relief printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the relief printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove solvent.

The resin composition for laser engraving may be produced by, for example, dissolving Components A, B, and as optional components, Component D to Component F, then Component C in an appropriate solvent.

The thickness of the (crosslinked) relief-forming layer in the relief printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a relief printing plate for laser engraving of the present invention is preferably a production process comprising a crosslinking step of crosslinking the relief-forming layer by means of heat to thus obtain a relief printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is usual to apply light to the entire surface of the relief-forming layer. Examples of the light (also called ‘actinic radiation’) include visible light, UV light, and an electron beam, but UV light is most commonly used. When the side where there is a substrate for fixing the relief-forming layer, such as a support for the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a vinyl chloride sheet on the relief-forming layer and evacuating.

The relief-forming layer may be crosslinked by heating the relief printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

### (Relief Printing Plate and Process for Making Same)

The process for making a relief printing plate of the present invention preferably comprises a layer formation step of forming a relief-forming layer from the resin composition for laser engraving of the present invention, a crosslinking step of crosslinking the relief-forming layer by means of heat and/or light to thus obtain a relief printing starting plate having a crosslinked relief-forming layer, and an engraving step of laser-engraving the relief printing starting plate having the crosslinked relief-forming layer, and more preferably comprises a layer formation step of forming a relief-forming layer from the resin composition for laser engraving of the present invention, a crosslinking step of crosslinking the relief-forming layer by means of heat to thus obtain a relief printing starting plate having a crosslinked relief-forming layer, and an engraving step of laser-engraving the relief printing starting plate having the crosslinked relief-forming layer

The relief printing plate of the present invention is a relief printing plate having a relief layer obtained by crosslinking and laser-engraving a layer formed from the resin composition for laser engraving of the present invention, and is preferably a relief printing plate made by the process for making a relief printing plate of the present invention.

The layer formation step and the crosslinking step in the process for making a relief printing plate of the present invention mean the same as the layer formation step and the crosslinking step in the above-mentioned process for producing a relief printing starting plate for laser engraving, and preferred ranges are also the same.

### <Engraving Step>

The process for producing a relief printing plate of the present invention preferably comprises an engraving step of laser-engraving the relief printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser or a semiconductor laser is preferable. In particular, a fiber-coupled semiconductor infrared laser (FC-LD) is preferably used. In general, compared with a CO2 laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate producing equipment comprising a fiber-coupled semiconductor laser that can be used suitably in the process for producing a relief printing plate employing the relief printing plate precursor of the present invention, those described in detail in JP-A-2009-172658 and JP-A-2009-214334 can be cited. Such equipment comprising a fiber-coupled semiconductor laser can be used to produce a relief printing plate of the present invention.

The process for producing a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2, and especially preferably no greater than 13.0. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The relief printing plate of the present invention having a relief layer may be produced as described above.

From the viewpoint of satisfying suitability for various aspects of flexographic printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 0.3 mm.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The relief printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The relief printing plate of the present invention has excellent rinsing properties, there is no engraving residue, since a relief layer obtained has excellent elasticity aqueous ink transfer properties and printing durability are excellent, and printing can be carried out for a long period of time without plastic deformation of the relief layer or degradation of printing durability.

According to the present invention, it was possible to provide a resin composition for laser engraving that can give a relief printing plate having excellent chemical resistance and that has excellent removability of engraving residue, a relief printing plate precursor using the resin composition for laser engraving, a process for making a relief printing plate using the precursor, and a relief printing plate obtained thereby.

### EXAMPLES

The present invention is explained in detail below by reference to Examples. Furthermore, ‘parts’ in the description below means ‘parts by weight’ unless otherwise specified.

Compounds used in Examples and Comparative Examples are shown below.

Polyvinyl butyral (Denka Butyral #3000-2, weight average molecular weight: 90,000, Denki Kagaku Kogyo K.K.)
Ketjen black EC600JD (carbon black, average primary particle diameter: 34.0 nm, made by Lion Corporation)
RM50 (silica particle, average particle diameter: 40 nm, Nippon Aerosil Co., Ltd.)
R711 (silica particle, average particle diameter: 12 nm, Nippon Aerosil Co., Ltd.))
SUNSPHERE H-31 (silica particle, average particle diameter: 3 μm, AGC SI-TECH. CO., LTD.)
SUNSPHERE NP-100 (silica particle, average particle diameter: 10 μm, AGC SI-TECH. CO., LTD.)
200CF (silica particle, average particle diameter: 12 nm, Nippon Aerosil Co., Ltd.))
Dispersing binder B-3 (above-mentioned dispersing agent B-3, weight average molecular weight: 20,000)
Dispersing binder B-7 (above-mentioned dispersing agent B-7, weight average molecular weight: 20,000)
Dispersing binder B-11 (above-mentioned dispersing agent B-11, weight average molecular weight: 20,000)
Dispersing binder X (polymer having a structure shown below, weight average molecular weight: 20,000)
Dispersing binder Y (polymer having a structure shown below, weight average molecular weight: 20,000)

| | Component 1 | | Component 2 | |
|---|---|---|---|---|
| | Structure | wt % | Structure | wt % |
| X | Single terminal methacryloylated polymethyl methacrylate (Mn: 6,000) | 60 | 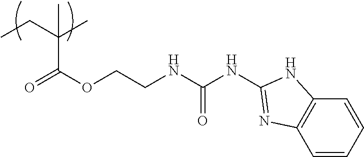 | 40 |
| Y | Single terminal methacryloylated polymethyl methacrylate (Mn: 6,000) | 35 | 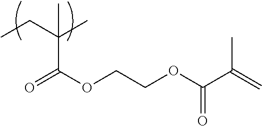 | 65 |

Monomer 1 (difunctional acrylate compound shown below)

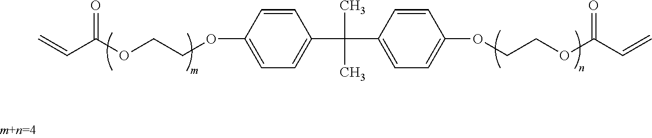

PERBUTYL Z (t-butyl peroxy benzoate, NOF CORPORATION)
IRGACURE 184 (α-hydroxy ketone, Ciba Specialty Chemicals)
Cresyldiphenyl phosphate (plasticizer, Tokyo Chemical Industry)
Zinc 2-ethylhexylate (Hope Chemical Co., LTD.)

### <Method for Synthesizing Dispersing Binder B-3>

### Monomers of Component 1 to Component 3

As Component 1, a single terminal methacryloylated polymethyl methacrylate (number average molecular weight (Mn)=6,000, trade name: AA-6, Toagosei Co., Ltd.) was used.

As Component 2, M′-1 shown below was used. M′-1 was synthesized by a method below.

13.3 parts of 2-aminobenzimidazole was dissolved in 30 parts of pyridine, which was heated to 45° C., and then 17.1 parts of 2-methacryloyloxyethyl isocyanate was dropped and additionally heated and stirred at 50° C. for 5 hr. The reaction liquid was poured into 200 parts of distilled water with stirring, and obtained precipitates were filtrated and washed to thus give 27.3 parts of M′-1.

As Component 3, M′-2 shown below, which is a precursor, was used. M′-2 was synthesized by means of a known method.

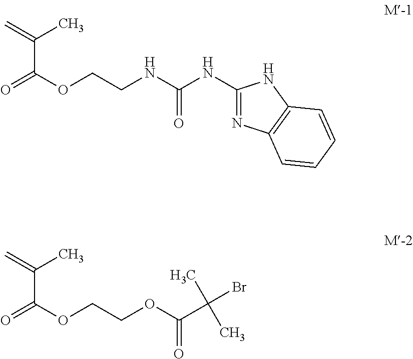

### Synthesis of Dispersing Binder B-3

A solution of a single terminal methacryloylated polymethyl methacrylate (Mn=6,000, trade name: AA-6, Toagosei Co., Ltd.) (60 parts), above-mentioned M′-1 (40 parts), above-mentioned M′-2 (100 parts), and an N,N-dimethylacetamide (300 parts) solution of dimethyl-2,2′-azobis(2-methyl propionate) (Wako Pure Chemical Industries, Ltd.) (1.63 parts) was dropped into N,N-dimethylacetamide (300 parts) under nitrogen flow at 80° C. over 2.5 hr. After the dropping, the solution was additionally stirred at 80° C. for 2 hr. After cooling, to the solution, N,N-dimethylacetamide (800 parts), p-methoxyphenol (Wako Pure Chemical Industries, Ltd.) (1.18 parts), 1,8-diazabicyclo[5.4.0]-7-undecene (Wako Pure Chemical Industries, Ltd.) (315 parts) were added, which was stirred at room temperature (25° C.) for 12 hr. After that, methanesulfonic acid (Wako Pure Chemical Industries, Ltd.) (200 parts) was dropped at 0° C. Then, the solution was thrown into water (1,700 parts) agitated vigorously and was stirred for 30 min. A precipitated white solid was filtrated and dried to thus give Dispersing binder B-3.

Dispersing binder B-3 was identified by means of gel permeation chromatography, NMR and IR spectrometry.

### <Method of Surface Treatment and Dispersion of Filler>

The method of surface treatment with a polymer having an ethylenically unsaturated group and dispersion of the filler were performed as follows.

A recipe below was dispersed with a motor mill (IGER CORP.) using zirconia beads having a diameter of 1.0 mm at a peripheral velocity of 9 m/s for 5 hr to thus give a filler dispersion liquid.

| | |
|---|---|
| Filler | 15 parts (dry weight) |
| Polymer having an ethylenically | 10 parts |
| unsaturated group shown in Table 1 | |
| Propylene glycol monomethyl acetate | 75 parts |

### Example 1

### <Thermal Crosslinking: Preparation of Relief Printing Plate Precursor 1 for Laser Engraving>

A three-necked flask equipped with a stirring blade and a condenser was charged with 40 parts of polyvinyl butyral, 10 parts (total amount of the filler and a polymer having an ethylenically unsaturated group) of Component A shown in Table 1, 25 parts of cresyldiphenyl phosphate, 3 parts of zinc 2-ethylhexylate and 100 parts of propyl glycol monoethyl ether acetate (PGMEA), which was heated and dissolved with stirring at 70° C. for 120 min.

After that, 20 parts of Monomer 1 was further added and stirred for 30 min. After that, 2 parts of PERBUTYL Z was added and stirred at 70° C. for 10 min. The operation gave a flowable resin composition for laser engraving.

A spacer (frame) having a predetermined thickness was placed on a PET substrate, the resin composition for laser engraving was cast gently so that it did not overflow from the spacer (frame), and dried in an oven at 100° C. for 3 hr to provide a relief-forming layer having a thickness of about 1 mm to thus prepare a relief printing plate precursor 1 for laser engraving.

### Examples 2 to 8, 11 and 12

### <Preparation of Relief Printing Plate Precursors 2 to 8, 11 and 12 for Laser Engraving>

A procedure similar to that for the relief printing plate precursor 1 for laser engraving in Example 1 was repeated except for replacing the kind and blending amount of Component A with those described in Table 1 to thus prepare respective relief printing plate precursors 2 to 8, 11 and 12 for laser engraving.

### Example 9

### <Photo Crosslinking: Preparation of Relief Printing Plate Precursor 9 for Laser Engraving>

A three-necked flask equipped with a stirring blade and a condenser was charged with 40 parts of polyvinyl butyral, 10 parts of Component A shown in Table 1, 25 parts of cresyldiphenyl phosphate, 3 parts of zinc 2-ethylhexylate and 100 parts of propyl glycol monoethyl ether acetate (PGMEA) as a solvent, which were heated and dissolved at 70° C. for 120 min with stirring.

After that, 20 parts of Monomer 1 was further added and stirred for 30 min. After that, 2 parts of IRGACURE 184 was added and stirred at 70° C. for 10 min. The operation gave a flowable resin composition for laser engraving.

A spacer (frame) having a predetermined thickness was placed on a PET substrate, the resin composition for laser engraving was cast gently so that it did not overflow from the spacer (frame), and dried in an oven at 80° C. for 3 hr. After it was air-dried, it was exposed so that the exposure amount on the plate surface became 2,000 mJ/cm² using an exposure machine using a metal halide lamp made by Ushio, Inc. to thus prepare a relief printing plate precursor 9 for laser engraving.

### Example 10

### <Surface Modification of Silica (Chemical Bond)>

100 parts of AEROSIL 200CF (Nippon Aerosil Co., Ltd.) was charged in a reaction tank, to which 1.5 parts of water was sprayed with stirring under nitrogen atmosphere. To the product, 10 parts of 3-methacryloxypropyltrimethoxysilane and 1.0 part of diethylamine was sprayed, which was heated and stirred at 150° C. for 1 hr, and then cooled to thus give a surface-modified 200CF.

### <Preparation of Relief Printing Plate Precursor 10 for Laser Engraving>

A three-necked flask equipped with a stirring blade and a condenser was charged with 40 parts of polyvinyl butyral, 10 parts of the surface-modified 200CF prepared above as Component A, 25 parts of cresyldiphenyl phosphate, 3 parts of zinc 2-ethylhexylate and 100 parts of propyl glycol monoethyl ether acetate (PGMEA) as a solvent, which were heated and dissolved at 70° C. for 120 min with stirring.

After that, 20 parts of Monomer 1 was further added and stirred for 30 min. After that, 2 parts of PERBUTYL Z was added and stirred at 70° C. for 10 min. The operation gave a flowable resin composition for laser engraving.

A spacer (frame) having a predetermined thickness was placed on a PET substrate, the resin composition for laser engraving was cast gently so that it did not overflow from the spacer (frame), and dried in an oven at 100° C. for 3 hr to provide a relief-forming layer having a thickness of about 1 mm to thus prepare a relief printing plate precursor 10 for laser engraving.

### Comparative Examples 1 to 4

### <Preparation of Relief Printing Plate Precursors C1 to C4 for Laser Engraving>

A procedure similar to that for the relief printing plate precursor 1 for laser engraving in Example 1 was repeated except for replacing the kind and blending amount of Component A with those described in Table 1 to thus prepare respective relief printing plate precursors C1 to C4 for laser engraving.

### <Preparation of Relief Printing Plate for Laser Engraving>

As a laser engraving machine, Adflex (Comtecs) was used. For obtained respective printing plate precursors for laser engraving, a half tone dot pattern (2×2 dots, height 300 μm) was engraved with the laser engraving machine under conditions of an output of 12 W, a head speed of 200 mm/sec, a pitch setting of 2,400 DPI to thus give respective relief printing plates.

### <Evaluation of Chemical Resistance>

Respective relief printing plate precursors prepared by the above-mentioned method were cut in 2 cm×2 cm, which were weighed before and after the immersion in 20 g of an isopropyl alcohol 20 wt % aqueous solution at 25° C. for 24 hr to measure the change in the weight. When the chemical resistance of the relief printing plate precursor is insufficient, the liquid permeates to increase the weight. It was evaluated that the weight change of 5% or less is a range that would cause no problems in practical use. The evaluation standard is as follows.

A: weight change was less than 1%

B: weight change was not less than 1% but less than 3.5%

C: weight change was not less than 3.5% but not more than 5%

D: weight change was more than 5%

### <Evaluation of Engraving Residue-Removing Properties>

Onto respective relief printing plates engraved by the above-mentioned method, a 0.01 N KOH aqueous solution (Wako Pure Chemical Industries, Ltd.) was dropped (about 100 ml/m²) with a dropper so as to wet evenly the plate surface, which was left at rest for 1 min, and was rubbed with a toothbrush (Clinica Toothbrush Flat, Lion Corporation) 20 times (for 30 sec in total) in parallel to the plate with a load of 200 gf. After that, the plate surface was washed with flowing water, moisture on the plate surface was removed, which was naturally dried for around 1 hr.

The surface of the plate obtained by natural drying was observed with a microscope having a magnification of 100 (Keyence Corporation) to evaluate the degree of engraving residues left behind over the plate. The evaluation standard is as follows.

A: no engraving residue is left behind over the plate

B: a little engraving residue is left behind in image bottom parts (concave parts) on the plate

C: engraving residues are left behind in both image convex parts and image bottom parts (concave parts) on the plate

D: engraving residues adhere dispersed over the whole area of the plate

A, B and C are a range that would cause no problems in practical use.

TABLE 1

| | | Component A | | Engraving | |
|---|---|---|---|---|---|
| | | | Addition | residue- | |
| | Crosslinking | | amount | removing | Chemical |
| | method | Kind | (wt %) | properties | resistance |
| Example | Thermal | Ketjen black EC600JD/ | 10 | A | A (<1%) |
| 1 | | Dispersing binder B-3 | | | |
| Example | Thermal | Ketjen black EC600JD/ | 5 | B | B (3%) |
| 2 | | Dispersing binder B-3 | | | |
| Example | Thermal | Ketjen black EC600JD/ | 1 | C | C (5%) |
| 3 | | Dispersing binder B-3 | | | |
| Example | Thermal | Ketjen black EC600JD/ | 20 | A | A (<1%) |
| 4 | | Dispersing binder B-3 | | | |
| Example | Thermal | RM50 (EVONIK INDUSTRIES) | 10 | A | B (3%) |
| 5 | | Dispersing binder B-3 | | | |
| Example | Thermal | R711 (EVONIK INDUSTRIES) | 10 | B | B (3%) |
| 6 | | Dispersing binder B-3 | | | |
| Example | Thermal | SUNSHPERE H-31 | 10 | A | A (<1%) |
| 7 | | Dispersing binder B-3 | | | |
| Example | Thermal | SUNSHPERE NP-100 | 10 | B | B (3%) |
| 8 | | Dispersing binder B-3 | | | |
| Example | Photo | Ketjen black EC600JD/ | 10 | A | A (<1%) |
| 9 | | Dispersing binder B-3 | | | |
| Example | Thermal | Surface-modified 200CF | 10 | A | A (<1%) |
| 10 | | | | | |
| Example | Thermal | Ketjen black EC600JD/ | 10 | A | A (<1%) |
| 11 | | Dispersing binder B-7 | | | |
| Example | Thermal | Ketjen black EC600JD/ | 10 | A | A (<1%) |
| 12 | | Dispersing binder B-11 | | | |
| Comp. | Thermal | Ketjen black EC600JD/ | 10 | B | D (10%) |
| Ex. 1 | | (no ethylenically | | | |
| | | unsaturated group) | | | |
| Comp. | Thermal | No filler/Dispersing | 10 | D | C (5%) |
| Ex. 2 | | binder B-3 alone | | | |
| Comp. | Thermal | Ketjen black EC600JD/ | 10 | B | D (12%) |
| Ex. 3 | | Dispersing binder X | | | |
| Comp. | Thermal | Ketjen black EC600JD/ | 10 | B | D (12%) |
| Ex. 4 | | Dispersing binder Y | | | |

In Table 1, with regard to the addition amount of Component A, the total amount of the filler and the polymer having an ethylenically unsaturated group is shown as a solid amount (content excluding the solvent) in the resin composition.

In Comparative Example 4, it was confirmed that Dispersing binder Y was not adsorbed physically to the filler, but was isolated from it, that is, the filler did not have an ethylenically unsaturated group.

What is claimed is:

1. A resin composition, comprising:
(Component A) a filler having an ethylenically unsaturated group,
(Component B) a polymerizable compound having an ethylenically unsaturated group, and
(Component C) a polymerization initiator.

2. The resin composition according to claim 1, wherein Component A is an inorganic filler having an ethylenically unsaturated group.

3. The resin composition according to claim 2, wherein the inorganic filler has a spherical form.

4. The resin composition according to claim 2, wherein the inorganic filler has a layered form.

5. The resin composition according to claim 2, wherein the inorganic filler is carbon black.

6. The resin composition according to claim 2, wherein the inorganic filler is silica.

7. The resin composition according to claim 2, wherein the inorganic filler is mica.

8. The resin composition according to claim 1, wherein Component C is a thermal polymerization initiator.

9. The resin composition according to claim 1, wherein the composition further comprises (Component D) a binder polymer.

10. The resin composition according to claim 1, wherein the composition further comprises (Component E) a plasticizer.

11. The resin composition according to claim 1, wherein the composition further comprises (Component F) at least one oxy compound of metals and metalloids selected from Groups I to XVI of the periodic table.

12. The resin composition according to claim 1, wherein Component A is a filler comprising a polymer having an ethylenically unsaturated group on the surface thereof, and the polymer has a monomer unit having an ethylenically unsaturated group and a monomer unit denoted by Formula (Ad-1′) below, 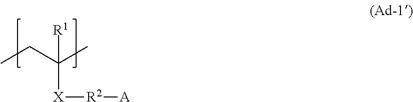
wherein R¹ denotes a hydrogen atom or a substituted or unsubstituted alkyl group, R² denotes a single bond or a divalent linking group, X denotes —CO—, —C(═O)O—, —CONH—, —OC(═O)— or a phenylene group, and A denotes a substituted or unsubstituted nitrogen-containing heterocyclic group.

13. The resin composition according to claim 1, wherein Component A is a filler in which a group having an ethylenically unsaturated group is chemically bonded to the surface thereof.

14. A relief printing plate precursor, comprising a relief-forming layer comprising the resin composition according to claim 1.

15. A relief printing plate precursor, comprising a crosslinked relief-forming layer formed by crosslinking by means of light and/or heat a relief-forming layer comprising the resin composition according to claim 1.

16. A process for producing a relief printing plate precursor, comprising:
a layer formation step of forming a relief-forming layer comprising the resin composition according to claim 1, and
a crosslinking step of crosslinking the relief-forming layer by light and/or heat to thus obtain a relief printing plate precursor having a crosslinked relief-forming layer.

17. A process for making a relief printing plate, comprising:
a layer formation step of forming a relief-forming layer comprising the resin composition according to claim 1,
a crosslinking step of crosslinking the relief-forming layer by light and/or heat to thus obtain a relief printing plate precursor having a crosslinked relief-forming layer, and
an engraving step of laser-engraving the relief printing plate precursor having a crosslinked relief-forming layer to thus form a relief layer.

18. The process for making a relief printing plate according to claim 17, wherein the laser-engraving is performed by means of a laser of 700 to 1,300 nm.

19. The process for making a relief printing plate according to claim 17, wherein the process further comprises a cleaning step of cleaning the surface of the relief layer after the engraving by means of water or an aqueous solution.

20. A relief printing plate comprising a relief layer made by the process for making a relief printing plate according to claim 17.
